(19) United States
(12) Patent Application Publication
(10) Pub. No.: US 2024/0028895 A1
(43) Pub. Date: Jan. 25, 2024

(54) SWITCHABLE ONE-SIDED SPARSITY ACCELERATION

(71) Applicants: Arnab Raha, San Jose, CA (US); Deepak Abraham Mathaikutty, Chandler, AZ (US); Dinakar Kondru, Frisco, TX (US); Umer Iftikhar Cheema, Hillsboro, OR (US); Martin Power, Dublin (IE); Niall Hanrahan, Galway (IE)

(72) Inventors: Arnab Raha, San Jose, CA (US); Deepak Abraham Mathaikutty, Chandler, AZ (US); Dinakar Kondru, Frisco, TX (US); Umer Iftikhar Cheema, Hillsboro, OR (US); Martin Power, Dublin (IE); Niall Hanrahan, Galway (IE)

(21) Appl. No.: 18/476,594

(22) Filed: Sep. 28, 2023

(51) Int. Cl. G06N 3/08; G06N 3/0464

(52) U.S. Cl. CPC G06N 3/08; G06N 3/0464

(57) ABSTRACT

A load module in a deep neural network (DNN) accelerator may receive a configuration parameter indicating a selection between an activation sparsity mode and a weight sparsity mode. The load module may read a sparse activation tensor, an activation sparsity bitmap, a sparse weight tensor, and a weight sparsity bitmap from a memory. The load module may densify one of the compressed tensors based on the sparsity mode and leave the other compressed tensor as is. The load module may load the dense tensor and the sparse tensor to a sparse cell. The sparse cell includes a sparsity module that may select one or more elements of the dense tensor based on the sparsity bitmap of the sparse tensor. The sparse cell also includes multiply-accumulate (MAC) units that perform MAC operation on the selected elements and the sparse tensor. MAC operations on unselected elements of the dense tensor are skipped.

### TECHNICAL FIELD

This disclosure relates generally to neural networks (also referred to as “deep neural networks” or “DNN”), and more specifically, switchable sparsity-based acceleration of DNNs.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN system, in accordance with various embodiments.

FIG. 4 is a block diagram of a DNN module, in accordance with various embodiments.

FIG. 5 illustrates a load module facilitating switchable one-sided sparsity acceleration, in accordance with various embodiments.

FIG. 6 illustrates a densification process, in accordance with various embodiments.

FIG. 7 illustrates sparsity acceleration in an MAC operation by a processing element (PE), in accordance with various embodiments.

FIG. 8 illustrates a sparse cell, in accordance with various embodiments.

FIG. 9 illustrates a sparse cell array, in accordance with various embodiments.

FIG. 10 illustrates read ports for reading sparsity operands for two-sided sparsity acceleration, in accordance with various embodiments.

FIG. 11 illustrates one read port for reading sparsity operands for one-sided sparsity acceleration, in accordance with various embodiments.

FIG. 12 illustrates a data drain approach for facilitating switchable one-sided sparsity acceleration, in accordance with various embodiments.

FIG. 13 is a block diagram of a PE, in accordance with various embodiments.

FIG. 14 is a flowchart showing a method of selecting sparsity mode, in accordance with various embodiments.

FIG. 15 is a flowchart showing a method of accelerating a deep learning operation, in accordance with various embodiments.

FIG. 16 is a flowchart showing another method of accelerating a deep learning operation, in accordance with various embodiments.

FIG. 17 is a block diagram of an example computing device, in accordance with various embodiments.

### DETAILED DESCRIPTION

### Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations (also referred to as “neural network operations”), such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

The fundamental operation of a convolution is MAC operations between input activations and kernel weights. Convolutions exhibit sparsity in the form of input activations and weights, as many of these data elements can have zero values. These zeros do not contribute to the accumulation of partial sums during the MAC operations. Nonlinear activation functions, such as rectified linear activation function (ReLU), can be present as post processing operations of convolution and can lead to sparsity in activations of subsequent layers. As ReLU typically clamps all negative value to zero, it can result in a significant number of zeros being present in the output activations, which are input activations of subsequent layers. Such sparsity-introducing activation functions is the main source of activation sparsity. On the weight side, sparsity may be introduced post training by pruning small magnitude values and replacing them with zero. During training, sparsity can be introduced by employing techniques such as certain types of regularization to encourage weight values to zero.

Leveraging sparsity in DNN accelerators can be crucial for achieving efficient and scalable AI systems. By taking advantage of sparsity, DNN accelerators can reduce the amount of computation and memory accesses required for a given task, leading to faster and more energy-efficient execution of DNNs. Sparsity can also enable the deployment of larger models with higher accuracy without requiring more expensive hardware. There are a number of sparse neural network accelerator (NNA) architectures. A sparse NNA typically needs to read in both the data and control information where the control is used to indicate where the nonzero data elements are located. Of the various sparse architectures, different architecture use different control formats to represent the sparse data, such as run-length-encoded streams, coordinate lists, or bit masks of nonzero entries.

A bit mask of nonzero entries may also be referred to as a sparsity map or a sparsity vector. Weight sparsity vectors can be generated offline, e.g., before a DNN execution process is started, and stored in memory. A DNN execution process may include inputting data into the DNN, executing deep learning operations in the DNN, and generating an output of the DNN. A DNN execution process may be used for DNN training or inference of a trained DNN. Activation sparsity vectors can be generated at run time (e.g., during a DNN execution process) and written to memory by the NNA. The sparsity vectors may contain a bit entry for every element in the weight tensor or activation tensor. The weight tensor or activation tensor written to memory may be compressed by removing the zeros in the weight tensor or activation tensor. The compressed format of a weight tensor or activation tensor may be referred to as “compressed data,” “sparse data,” or “packed data,” versus the uncompressed format of a weight tensor or activation tensor (i.e., no data elements are removed) may be referred to as “dense data.” This sparsity approach has several benefits. First, combining weight and activation sparsity to remove and skip redundant computation allows faster processing of layers, reduced power consumption and provides sparse acceleration. The packing of data written to memory with the removal of zeros, not only reduces the cost of data movement as well as the bandwidth requirement for reading in weights and activations, but also results in a smaller storage requirement.

Currently available DNN accelerators can leverage the underlying sparsity in activations and weights to accelerate the DNN computation. Some DNN accelerators can use fixed one-sided sparsity either in the weight or activation side. Some DNN accelerators can use two-sided combined sparsity and can achieve higher acceleration due to the skipping of zeros in both activations and weights, but that comes at the cost of higher area or power overheads compared to fixed one-sided sparsity. While in general, sparsity improves bandwidth overall, the reading of the control vector, with a bit per byte of activations/weights, means that there is an overhead to reading in the control information as well as the data when compared to a fully dense architecture.

Many recently developed deep learning models (e.g., transformers, etc.) have moved on from ReLU-based activation functions. Some models may not be trained for sparsity (or structured sparsity) but can be trained for sparsity, subsequently perform “thinning” of the model resulting in a leaner/smaller model having a smaller number of nonzero input channels and output channels per DNN layer. DNN accelerators that can exploit unstructured sparsity for achieving high eTOPS/mm2 and eTOPS/W could perform a wider MAC operation in the channel dimension potentially resulting in lesser opportunities for compute acceleration. In addition, this can reduce the additional compute acceleration that can be achieved from two-sided (i.e., weight and activation) sparsity compared to the acceleration achieved from one-sided (i.e., weight or activation) sparsity separately.

Embodiments of the present disclosure may improve on at least some of the challenges and issues described above by providing DNN accelerators with switchable sparsity load. An example DNN accelerator in the present disclosure can facilitate configurable, one-sided sparsity acceleration. The DNN accelerator can be configured to skip MAC operations based on either weight sparsity or activation sparsity, and the selection between weight sparsity and activation sparsity is configurable. For instance, weight sparsity and activation sparsity may be measured and compared to determine which side can provide greater compute acceleration. A configuration parameter indicating the selection between weight sparsity and activation sparsity can be provided to sparsity control modules in the DNN accelerator so that the DNN accelerator can achieve skip MAC operations with the selected sparsity, achieving the greater compute acceleration. As the sparsity acceleration is one-sided, the area and power overhead for facilitating the sparsity acceleration would be lower compared with two-sided sparsity acceleration. Therefore, the DNN accelerations in the present disclosure can have better performance than currently available DNN accelerators.

In various embodiments of the present disclosure, a DNN accelerator may include one or more compute blocks. A compute block may include a memory, a load module, and one or more sparse cells. The memory may store a sparse activation tensor, an activation sparsity bitmap, a sparse weight tensor, and a weight sparsity bitmap. The load module may receive a configuration parameter indicating a selection between an activation sparsity mode and a weight sparsity mode. The load module may generate a dense activation tensor by densifying the sparse activation tensor based on the activation sparsity bitmap when the weight sparsity mode is selected but generate a dense weight tensor by densifying the sparse weight tensor based on the weight sparsity bitmap when the activation sparsity mode. The load module may load data to a sparsity cell. The sparse cell may include a sparsity module and one or more MAC units. The sparse cell may also have a storage unit for storing dense tensors (either dense activation tensor or dense weight tensor), another storage unit for storing compressed tensors (either sparse activation tensor or sparse weight tensor), and yet another storage unit for storing sparsity bitmaps.

Data loaded to the sparsity cell can be different in different modes. In the weight sparsity mode, the load module may load the dense activation tensor, the sparse weight tensor, and the weight sparsity bitmap to a sparse cell. The sparsity module may select one or more activations from the dense activation tensor based on the weight sparsity bitmap and transmit the selected activations to the MAC units. The MAC unit may perform MAC operation on the selected activations and the sparse weight tensor. In the activation sparsity mode, the load module may load the dense weight tensor, the sparse activation tensor, and the activation sparsity bitmap to the sparse cell. The sparsity module may select one or more weights from the dense weight tensor based on the activation sparsity bitmap and transmit the selected weights to the MAC units. The MAC unit may perform MAC operation on the selected weights and the sparse activation tensor.

The present disclosure provides an approach that can facilitate efficient sparsity acceleration in DNN accelerators with a good balance between achieving compute acceleration and reducing area and power overhead. Compared to fixed one-sided sparsity acceleration, the switchable sparsity acceleration in the present disclosure can explore both activation and weight sparsity. Both structured (or unstructured) weight sparsity as well as activation sparsity due to activation functions can be exploited. Compared to two-sided sparsity acceleration, switchable sparsity acceleration can be significantly more area and energy efficient as it can eliminate the extra area and power overheads required to exploit both activation and weight sparsity simultaneously. For instance, compared with two-sided sparsity accelerators, DNN accelerators in the present disclosure would need less sparsity controlling of MAC units in the sparse cell and less multiplexing for the storage units in the sparse cell.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

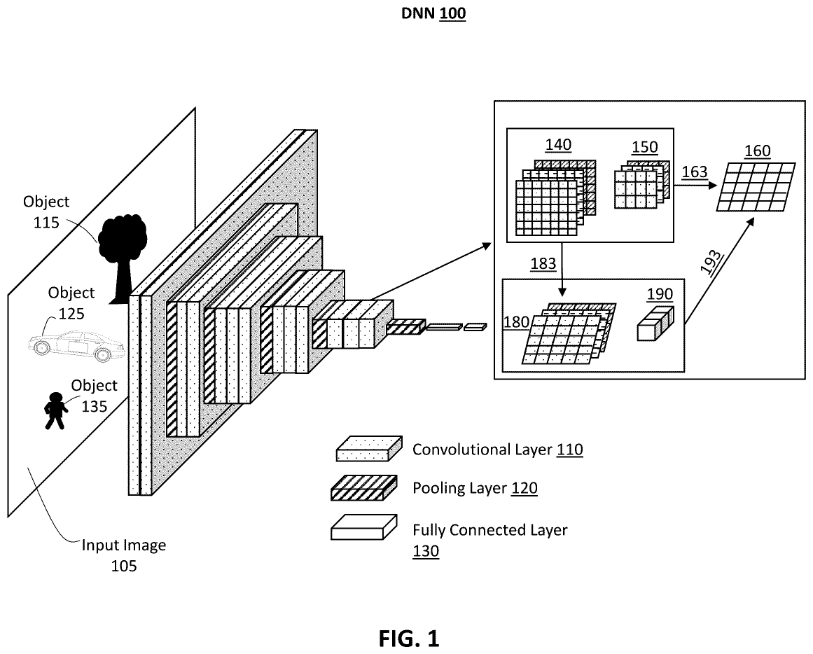

FIG. 1 illustrates an example DNN 100, in accordance with various embodiments. For the purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an execution of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is ReLU. ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generate a new feature map. The new feature map may also be normalized and resized. The new feature map can be kernelled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a SoftMax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, SoftMax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

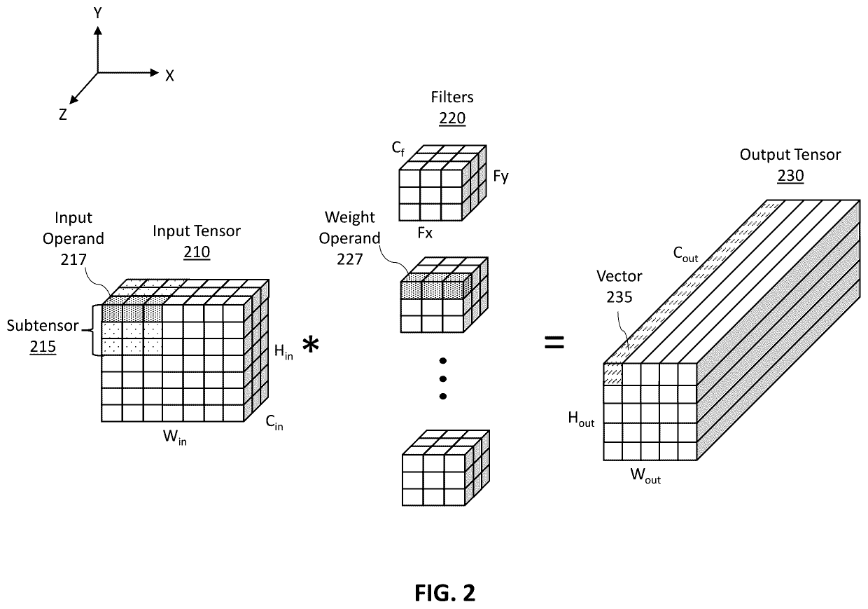

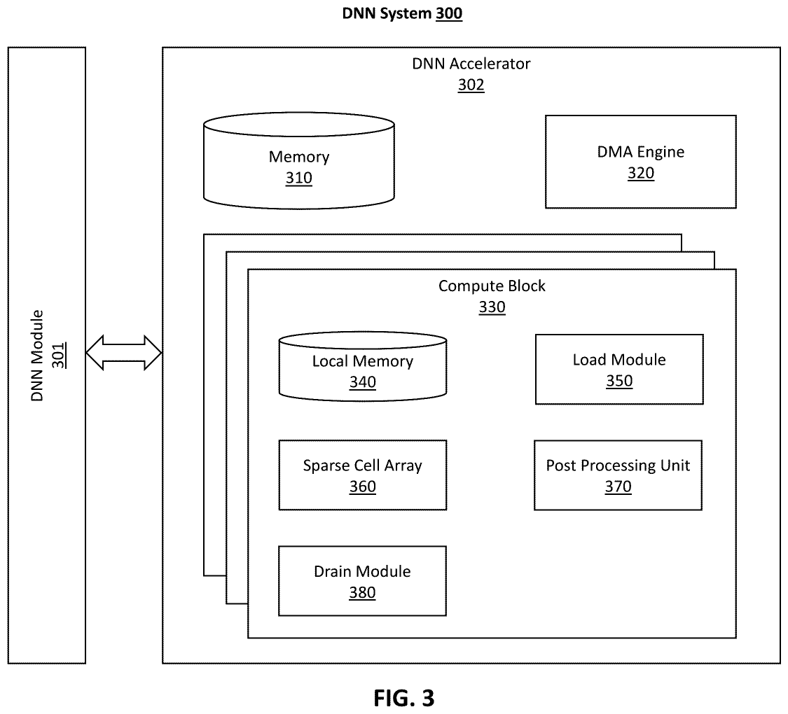

FIG. 2 illustrates an example convolution, in accordance with various embodiments. The convolution may be a deep learning operation in a convolutional layer of a DNN, e.g., a convolutional layer 110 in FIG. 1. The convolution can be executed on an input tensor 210 and filters 220 (individually referred to as “filter 220”). The result of the convolution is an output tensor 230. In some embodiments, the convolution is performed by a DNN accelerator. An example of the DNN accelerator may be the DNN accelerator 302 in FIG. 3.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ× Wᵢₙ× Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For the purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 2×3×3, i.e., the filter 220 includes 2 convolutional kernels with a spatial size of 2×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 2×3×3 subtensor 215 (which is highlighted with a dotted pattern in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (X, Y) coordinate, but the output activations correspond to different output channels and have different Z coordinates. The dimension of the vector 235 along the Z axis may equal the total number of output channels in the output tensor 230. After the vector 235 is produced, further MAC operations are performed to produce additional vectors till the output tensor 230 is produced.

In some embodiments, the MAC operations on a 2×3×3 subtensor (e.g., the subtensor 215) and a filter 220 may be performed by a plurality of PEs. One or more PEs may receive an input operand (e.g., an input operand 217 shown in FIG. 2) and a weight operand (e.g., the weight operand 227 shown in FIG. 2). The input operand 217 includes a sequence of activations having the same (x, y) coordinate but different z coordinates. The input operand 217 includes an activation from each of the input channels in the input tensor 210. The weight operand 227 includes a sequence of weights having the same (x, y) coordinate but different z coordinates. The weight operand 227 includes a weight from each of the channels in the filter 220. Activations in the input operand 217 and weights in the weight operand 227 may be sequentially fed into a PE. The PE may receive an activation and a weight (“an activation-weight pair”) at a time and multiple the activation and the weight. The position of the activation in the input operand 217 may match the position of the weight in the weight operand 227. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 230 may be further processed based on one or more activation functions before they are stored or inputted into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the input tensor 210 may be results of post processing of the previous DNN layer.

Example DNN System

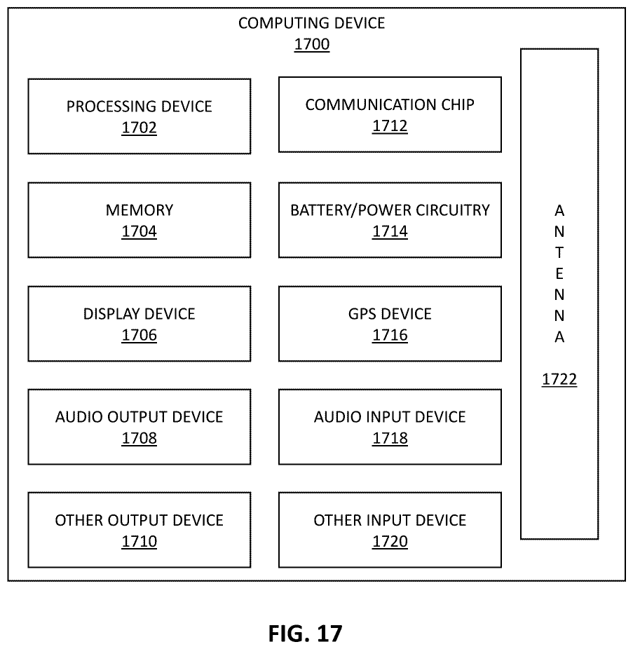

FIG. 3 is a block diagram of a DNN system 300, in accordance with various embodiments. The whole DNN system 300 or a part of the DNN system 300 may be implemented in one or more computing devices, such as the computing device 1700 in FIG. 17. The DNN system 300 can generate and execute DNNs, such as the DNN 100 in FIG. 1. As shown in FIG. 3, the DNN system 300 includes a DNN module 301 and a DNN accelerator 302. In other embodiments, alternative configurations, different or additional components may be included in the DNN system 300. For instance, the DNN system 300 may include multiple DNN modules or multiple DNN accelerators. Further, functionality attributed to a component of the DNN system 300 may be accomplished by a different component included in the DNN system 300 or a different system. In some embodiments, the DNN module 301 and DNN accelerator 302 may include different types of processing units. The DNN module 301 and DNN accelerator 302 may be implemented in the same chip or separate chips.

The DNN module 301 facilitates generation and deployment of DNNs. In some embodiments, the DNN module 301 may generate and train DNNs. For instance, the DNN module 301 can define the layered architecture of a DNN. The DNN module 301 can also determine the internal parameters of the DNN through a DNN training process. The DNN module 301 may also determine one or more hyperparameters that define how the DNN is trained. An example hyperparameter is a sparsity ratio that defines the sparsity level of one or more deep learning tensors for the DNN.

The DNN module 301 may also compress DNNs, e.g., during or after training. In some embodiments, the DNN module 301 may prune weights in one or more layers of a DNN by changing nonzero valued weight to zeros. The DNN module 301 may prune weights based on a target weight sparsity ratio. A weight sparsity ratio may be the ratio of the number of zero-valued weights to the total number of weights. In an example where the DNN module 301 prunes weight during DNN training, the DNN module 301 may prune weight of a layer to achieve a target sparsity ratio after one or more epochs. The DNN module 301 may prevent the pruned weights from changing values during the rest of the training process. Alternatively, the DNN module 301 may allow the pruned weights to change values so that a pruned, zero-valued weight may have a nonzero value after further training. The DNN module 301 may prune weights of the layer again after one or more additional epochs.

The DNN module 301 may deploy trained, compressed, or validated DNNs for use in deep learning applications. The DNN module 301 may control execution processes of trained, compressed, or validated DNNs. For instance, the DNN module 301 may configure a sparsity mode of a DNN accelerator that performs execution of a DNN. To configure the sparsity mode, the DNN module 301 may select an activation sparsity mode in which the DNN accelerator may skip MAC operations based on sparsity in activations or a weight sparsity mode in which the DNN accelerator may skip MAC operations based on sparsity in weights. The DNN module 301 may generate a configuration parameter, the value of which indicates the selection. The DNN module 301 may provide the configuration parameter to the DNN accelerator and the DNN accelerator may perform the DNN execution in the sparsity mode indicated by the configuration parameter.

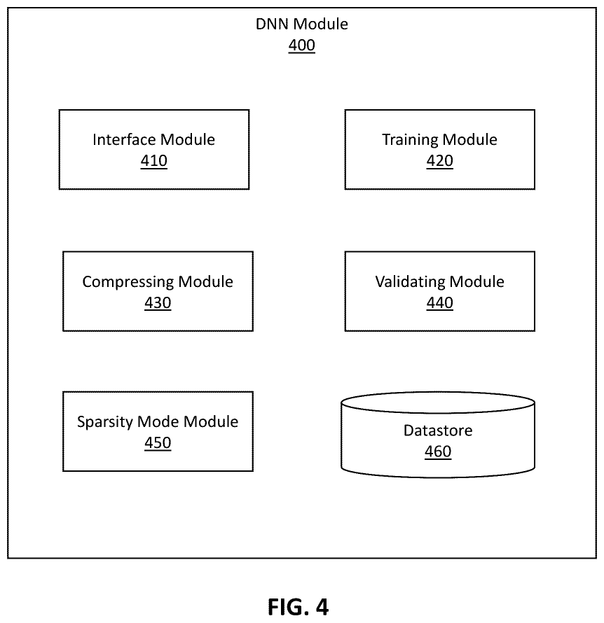

In some embodiments, the DNN module 301 may distribute trained, compressed, or validated DNNs to devices or systems which may use the DNNs to perform tasks (e.g., image classification, motion planning, etc.) for which the DNNs were trained. In other embodiments, the DNN module 301 may facilitate deployment of the DNNs using the DNN accelerator 302. For instance, the DNN module 301 may receive data from a device or system coupled with the DNN system 300 and input the received data (or data generated by the DNN module 301, e.g., based on the received data) into a DNN. The DNN module 301 may generate instructions (e.g., configuration files) that control the operation of the DNN accelerator 302 during the DNN execution. The DNN module 301 may receive an output of the DNN from the DNN accelerator 302. The DNN module 301 may transmit the output of the DNN (or a result of processing the output of the DNN by the DNN module 301) to the device or system. Certain aspects of the DNN module 301 are provided below in conjunction with FIG. 4.

The DNN accelerator 302 executes DNNs provided by the DNN module 301. For instance, the DNN accelerator 302 can perform DNN execution, e.g., by running deep learning operations in the DNNs, for training DNNs or for using the trained/compressed/validated DNNs to perform tasks. As shown in FIG. 3, the DNN accelerator 302 includes a memory 310, a DMA (direct memory access) engine 320, and compute blocks 330 (individually referred to as “compute block 330”). In other embodiments, alternative configurations, different or additional components may be included in the DNN accelerator 302. For example, the DNN accelerator 302 may include more than one memory 310 or DMA engine 320. As another example, the DNN accelerator 302 may include a single compute block 330. Further, functionality attributed to a component of the DNN accelerator 302 may be accomplished by a different component included in the DNN accelerator 302 or by a different system. A component of the DNN accelerator 302 may be implemented in hardware, software, firmware, or some combination thereof.

The memory 310 stores data associated with deep learning operations performed by the DNN accelerator. In some embodiments, the memory 310 may store data to be used by the compute blocks 330 for DNN execution. For example, the memory 310 may store weights, such as weights of convolutional layers, which are determined by training DNNs. As another example, the memory 310 may store inputs to DNNs or outputs of DNNs. The memory 310 may also store data generated by the compute blocks 330 from performing deep learning operations in DNNs. Example deep learning operations include convolutions (also referred to as “convolutional operations”), pooling operations, elementwise operations, activation functions, other types of deep learning operations, or some combination thereof. The memory 310 may be a main memory of the DNN accelerator 302. In some embodiments, the memory 310 includes one or more dynamic random-access memories (DRAMs).

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 can perform deep learning operations in DNNs. For instance, a compute block 330 may run a deep learning operation in a DNN layer, or a portion of the deep learning operation, at a time. The compute blocks 330 may be capable of running various types of deep learning operations, such as convolution, pooling, elementwise operation, linear operation, nonlinear operation, and so on. In an example, a compute block 330 may perform convolutions, e.g., standard convolution or depthwise convolution. In some embodiments, the compute block 330 receives an input tensor and one or more convolutional kernels and performs a convolution with the input tensor and convolutional kernels. The result of the convolution may be an output tensor, which can be further computed, e.g., by the compute block 330 or another compute block 330. In some embodiments, the operations of the DNN layers may be run by multiple compute blocks 330 in parallel. For instance, multiple compute blocks 330 may each perform a portion of a workload for a convolution. Data may be shared between the compute blocks 330. A compute block 330 may also be referred to as a compute tile. In some embodiments, each compute block 330 may be a processing unit.

In the embodiments of FIG. 3, each compute block 330 includes a local memory 340, a load module 350, a sparse cell array 360, a post processing unit 370, and a drain module 380. Some or all the components of the compute block 330 can be implemented on the same chip. In other embodiments, alternative configurations, different or additional components may be included in the compute block 330. Further, functionality attributed to a component of the compute block 330 may be accomplished by a different component included in the compute block 330, a different compute block 330, another component of the DNN accelerator 302, or a different system. A component of the compute block 330 may be implemented in hardware, software, firmware, or some combination thereof.

The local memory 340 is local to the corresponding compute block 330. In the embodiments of FIG. 3, the local memory 340 is inside the compute block 330. In other embodiments, the local memory 340 may be outside the compute block 330. Data in the local memory 340 may be transferred to or from the memory 310, e.g., through the DMA engine 320. In some embodiments, data in the local memory 340 may be transferred to or from the local memory of another compute block 330. The local memory 340 may store data received, used, or generated by the sparse cell array 360 and the post processing unit 370. Examples of the data may include input activations, weights, output activations, sparsity bitmaps, and so on.

In some embodiments, the local memory 340 may store dense tensors (e.g., dense activation tensors, dense weight tensors, etc.), sparse tensors (e.g., sparse activation tensors, sparse weight tensors, etc.), and so on. A dense tensor may be a tensor from which zero-valued elements (if any) are not removed. A dense tensor may be converted to a sparse tensor by removing one or more zero-valued elements in the dense tensor. A sparse tensor may also be referred to as a compressed tensor or packed tensor. The process of converting a dense tensor to a sparse tensor may be referred to as sparsity encoding. Sparsity encoding may also generate a sparsity tensor. Each element in the sparsity tensor may correspond to a different element in the dense tensor and indicate whether the element in the dense tensor is zero or not. The sparsity tensor may indicate positions of elements of the sparse tensor in the dense tensor. The sparsity tensor may be a sparsity bitmap, each element of which is a bit. A sparse tensor may be converted to a dense tensor through a densifying process, in which one or more zeros may be added to the sparse tensor based on the sparsity tensor.

In some embodiments, the local memory 340 includes one or more static random-access memories (SRAMs). The local memory 340 may be byte-addressable, and each memory address identifies a single byte (eight bits) of storage. In some embodiments, the local memory 340 may include memory banks. The number of data banks in the local memory 340 may be 16, 64, 128, 356, 512, 1024, 3048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 340 in a single read cycle. In other embodiments, 16 bits can be transferred from the local memory 340 in multiple read cycles, such as two cycles.

The load module 350 loads data from the local memory 340 to the sparse cell array 360. The load module 350 may read tensors from the local memory 340. The tensors may include sparse activation tensors, sparse weight tensors, activation sparsity tensors, weight sparsity tensors, and so on. In some embodiments, the load module 350 has two operation modes: an activation sparsity mode and a weight sparsity mode. The operation mode of the load module 350 is configurable and switchable. For instance, the load module 350 may receive a configuration parameter, e.g., from the DNN module 301, and operate in the operation mode indicated by the configuration parameter. The load module 350 may operate in one of the operation modes at a time.

In the weight sparsity mode, the load module 350 may densify sparse activation tensors to generate dense activation tensors based on corresponding activation sparsity tensors. For instance, the load module 350 may add one or more zeros into a sparse activation tensor based on an activation sparsity tensor associated with the sparse activation tensor to generate the dense activation tensor. The dense activation tensor includes one or more elements than the sparse activation tensor. The additional element(s) are zero valued. The load module 350 may identify one or more elements in the activation sparsity tensor that correspond to the zero-valued element(s), determine the position of each of the zero-valued element(s) in the dense activation tensor, and insert the zero-valued element(s) into the sparse activation tensor based on the determined positions. After the densification, the load module 350 may transmit the dense activation tensors to the sparse cell array 360. The load module 350 may also transmit corresponding sparse weight tensors and weight sparsity tensors to the sparse cell array 360. Activation sparsity tensor of the dense activation tensors may not be loaded to the sparse cell array 360.

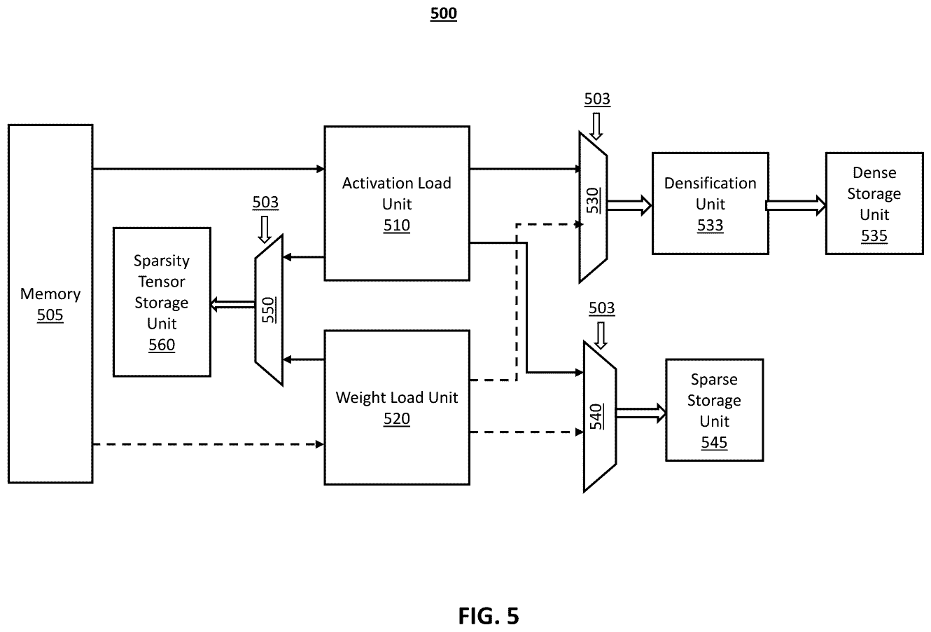

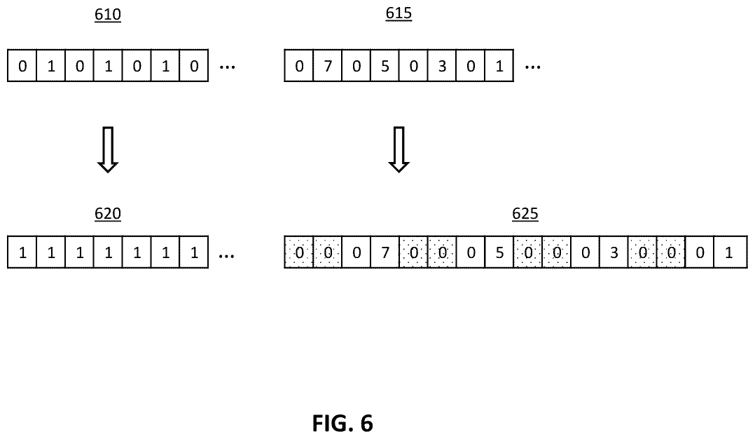

In the activation sparsity mode, the load module 350 may densify sparse weight tensors to generate dense weight tensors based on corresponding weight sparsity tensors by inserting zeros into sparse weight tensors. The densification of sparse weight tensors may be similar to the densification of sparse activation tensors described above. More details regarding densifying sparse tensors are described below in conjunction with FIG. 6. After the densification, the load module 350 may transmit the dense weight tensors to the sparse cell array 360. The load module 350 may also transmit corresponding sparse activation tensors and activation sparsity tensors to the sparse cell array 360. Weight sparsity tensor of the dense weight tensors may not be loaded to the sparse cell array 360. Certain aspects of the load module 350 are described below in conjunction with FIG. 5.

The sparse cell array 360 may include sparse cells arranged in columns, or columns and rows. Each sparse cell may include an array of MAC units that can perform MAC operations. In some embodiments (e.g., embodiments where the compute block 330 executes a convolutional layer), a computation in an MAC unit may be an MAC operation on an activation operand and a weight operand. The activation operand is an activation tensor that may include one or more activations in the input tensor of the convolution. Different activations may be in different input channels. The weight operand is a weight tensor that may include one or more weights in the filter of the convolution. The values of the weights are determined through training the DNN. The weights in the weight operand may be in different input channels.

In some embodiments, an MAC unit includes one or more multipliers for performing multiplications. An MAC unit may also include one or more accumulators (“adders”) for performing accumulations. A column of MAC units is referred to as an MAC column. An MAC column may be associated with one or more MAC lanes. An MAC lane is a path for loading data e.g., by the load module 350, into an MAC column. AN MAC lane may be also referred to as a data transmission lane or data loading lane. An MAC column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where an MAC column has four MAC lanes for feeding activations or weights into the MAC column and each MAC lane may have a bandwidth of 16 bytes, the four MAC lanes can have a total loading bandwidth of 64 bytes.

In some embodiments, the sparse cell array 360 may be capable of depthwise convolution, standard convolution, or both. In a depthwise convolution, an MAC unit may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the MAC unit. The sparse cell array 360 may output multiple output operands at a time, each of which is generated by a different MAC unit. In a standard convolution, MAC operations may include accumulations across the channels. For instance, as opposed to generating an output operand, a PE may accumulate products across different channels to generate a single output point.

In some embodiments, the sparse cell array 360 may perform MAC operations in quantized deep learning operations, such as MAC operations in a quantized convolution. In some embodiments, an MAC unit in the sparse cell array 360 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the MAC unit may be a real value in a floating-point format. The MAC unit may include no quantization subtractors as zero-point offsetting is not needed for the MAC operations in quantized deep learning operations.

In some embodiments, the sparse cell array 360 may include sparsity acceleration logic for facilitating sparsity acceleration. For instance, each sparse cell in the sparse cell array 360 may include one or more sparsity modules. In an example, each MAC column or each MAC row may have a corresponding sparsity module that accelerates MAC operations in the MAC column or MAC row. In some embodiments, a sparsity module accelerates computations in the sparse cell array 360 based on sparsity in activations or sparsity in weights. The sparsity module may include a storage unit that stores a sparsity tensor, which may be loaded to the storage unit by the load module 350. The sparsity tensor may be an activation sparsity tensor or a weight sparsity tensor.

The sparsity module can use the sparsity tensor to accelerate MAC operations on an activation operand and a weight operand. One of the operands may be stored as a dense tensor, and the other operand is stored in a sparse format as a sparse tensor. The sparsity module may control which data elements of the dense tensor will be transmitted to the corresponding MAC units based on the sparsity tensor. In some embodiments (e.g., embodiments where the sparsity tensor is an activation sparsity tensor), the dense tensor may be the weight operand and the sparse tensor may be the sparse form of the activation operand. In other embodiments (e.g., embodiments where the sparsity tensor is a weight sparsity tensor), the dense tensor may be the activation operand and the sparse tensor may be the sparse form of the activation operand. The sparsity tensor may have the same number of elements as the dense tensor but more elements than the sparse tensor. A sparsity element in the sparsity tensor corresponds to a data element in the dense tensor. For instance, the position of the sparsity element in the sparsity tensor may match the position of the data element in the dense tensor. Each sparsity element may correspond to a data element of the dense format of the sparse tensor and indicate whether the data element is zero or not. Sparsity elements in the sparsity tensor indicate positions of data elements of the sparse tensor in the dense format of the sparse tensor.

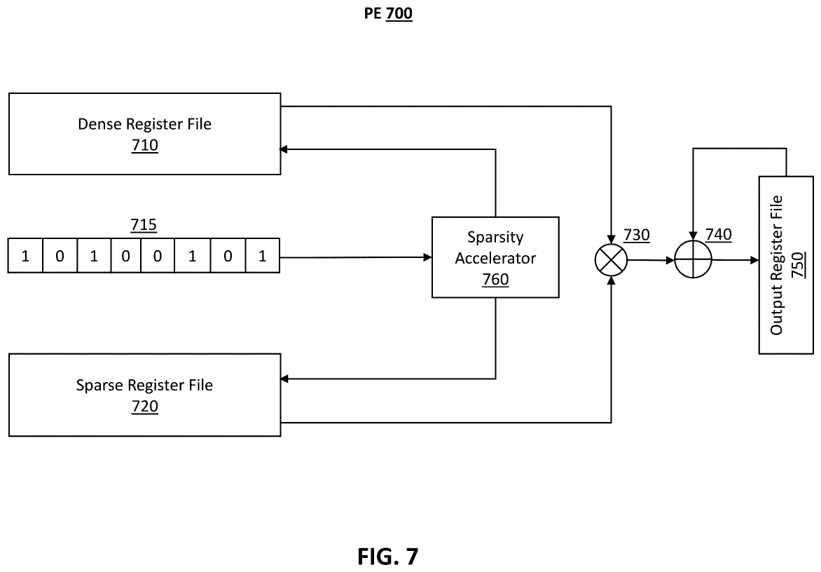

The sparsity module may use the sparsity tensor to identify which data elements of the dense tensor correspond to data elements of the sparse tensor. Each identified data element of the dense tensor and the corresponding data element of the sparse tensor may constitute an activation-weight pair for an MAC operation. For instance, the identified data element of the dense tensor will be multiplied with the corresponding data element of the sparse tensor in the MAC operation. The sparsity module may select one or more data elements of the dense tensor based on one or more sparsity elements of the sparsity tensor that correspond to one or more nonzero valued data elements of the dense format of the sparse tensor. The sparsity module can forward the identified activation-weight pairs to the MAC units. Other data elements of the dense tensor would be skipped and not computed by the MAC units to accelerate computation in the sparse cell array 360, as these data elements will not contribute to the result of the MAC operation. More details regarding sparsity acceleration are provided below in conjunction with FIG. 7.

The post processing unit 370 processes outputs of the sparse cell array 360. In some embodiments, the post processing unit 370 computes activation functions. The post processing unit 370 may receive outputs of the sparse cell array 360 as inputs to the activation functions. The post processing unit 370 may transmit the outputs of the activation functions to the local memory 340. The outputs of the activation functions may be retrieved later by the sparse cell array 360 from the local memory 340 for further computation. For instance, the post processing unit 370 may receive an output tensor of a DNN layer from the sparse cell array 360 and computes one or more activation functions on the output tensor. The results of the computation by the post processing unit 370 may be stored in the local memory 340 and later used as input tensor of the next DNN layer. In addition or alternative to activation functions, the post processing unit 370 may perform other types of post processing on outputs of the sparse cell array 360. For instance, the post processing unit 370 may apply a bias on an output of the sparse cell array 360.

The drain module 380 drains data from the sparse cell array 360 and writes the data to the local memory 340. The data may be outputs of MAC operations performed by MAC units in the sparse cell array 360. In some embodiments, the drain module 380 may drain data on a sparse cell level. For each sparse cell, the drain module 380 may drain outputs of MAC units in the sparse cell based on a row index or column index of each MAC unit. For instance, the drain module 380 may use a sequence of cycles to drain data from a sparse cell. The drain module 380 may drain the output of some of the MAC units in each cycle. The sequence of the cycles may be configured based on a configuration parameter indicating the operation mode of the load module 350.

In some embodiments, the drain module 380 may determine whether to drain the output of an MAC unit based on the column index of the MAC unit when the load module operates in the activation sparsity mode versus based on the row index of the MAC unit when the load module operates in the weight sparsity mode. For instance, for MAC operations where the load module 350 operates in the activation sparsity mode, the drain module 380 may drain the output of a different MAC column in each cycle. The sequence of cycles may start with the first MAC column (e.g., the MAC column on the left side of the sparse cell) and end with the last MAC column (e.g., the MAC column on the right side of the sparse cell). For MAC operations where the load module 350 operates in the weight sparsity mode, the drain module 380 may drain the output of a different MAC row in each cycle. The sequence of cycles may start with the first MAC row (e.g., the MAC row at the top of the sparse cell) and end with the last MAC row (e.g., the MAC column at the bottom of the sparse cell). In other embodiments, the drain module 380 may determine whether to drain the output of an MAC unit based on the row index of the MAC unit when the load module operates in the activation sparsity mode versus based on the column index of the MAC unit when the load module operates in the weight sparsity mode.

The sparsity encoder converts dense data to compressed data based on sparsity in the dense data. The sparsity encoder may execute pruning operations, such as activation pruning operations or weight pruning operations. The sparsity encoder may also generate sparsity bitmaps, including activation bitmaps and weight bitmaps, based on the pruning operations.

The drain module 380 may also include sparsity encoding logic (e.g., a sparsity encoder) that can convert outputs of the sparse cell array 360 from a dense format to a sparse format. In some embodiments, the data drained from the sparse cell array may be at least part of an output tensor (e.g., the output tensor 230 in FIG. 2) of a deep learning operation. The sparsity encoder may generate a compressed version of the output tensor. The sparsity encoder may identify every zero-valued activation in the output tensor and remove these activations from the output tensor to generate a sparse activation tensor. The sparsity encoder may also generate one or more sparsity tensors for the output tensor. A sparsity bitmap may correspond to a vector (e.g., the vector 235 in FIG. 2) in the output tensor. The sparsity map may include sparsity elements (e.g., bits), each of which corresponds to a different activation in the vector and indicates whether the corresponding activation is zeroed or not. The drain module 380 may write the sparse activation tensor and the one or more sparsity tensors into the local memory 340. The sparse activation tensor and the one or more sparsity tensors may be further loaded to the memory 310, e.g., through the DM engine 320. Additionally or alternatively, the sparse activation tensor and the one or more sparsity tensors may be loaded by the load module 350 to the sparse cell array for further computation, e.g., for performing a deep learning operation in the next layer.

FIG. 4 is a block diagram of a DNN module 400, in accordance with various embodiments. The DNN module 400 may be an embodiment of the DNN module 301 in FIG. 3. As shown in FIG. 4, the DNN module 400 includes an interface module 410, a training module 420, a compressing module 430, a validating module 440, a sparsity mode module 450, and a datastore 460. In other embodiments, alternative configurations, different or additional components may be included in the DNN module 400. Further, functionality attributed to a component of the DNN module 400 may be accomplished by a different component included in the DNN module 400 or a different module or system.

The interface module 410 facilitates communications of the DNN module 400 with other modules or systems. For example, the interface module 410 establishes communications between the DNN module 400 with an external database to receive data that can be used to train DNNs or input into DNNs to perform tasks. As another example, the interface module 410 supports the DNN module 400 to distribute DNNs to other systems, e.g., computing devices configured to apply DNNs to perform tasks.

The training module 420 trains DNNs by using a training dataset. The training module 420 forms the training dataset. In an embodiment where the training module 420 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 440 to validate performance of a trained DNN. The portion of the training dataset not including the tuning subset and the validation subset may be used to train the DNN.

The training module 420 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1000, or even larger.

The training module 420 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between two convolution layers. A fully connected layer involves weights, biases, and neurons. It connects neurons in one layer to neurons in another layer. It is used to classify images between different categories by training.

In the process of defining the architecture of the DNN, the training module 420 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 420 defines the architecture of the DNN, the training module 420 inputs a training dataset into the DNN. The training dataset includes a plurality of training samples. An example of a training sample includes an object in an image and a ground-truth label of the object. The training module 420 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 420 uses a cost function to minimize the error.

The training module 420 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 420 finishes the predetermined number of epochs, the training module 420 may stop updating the parameters in the DNN. The DNN having the updated parameters is referred to as a trained DNN.

The compressing module 430 compresses DNNs. For instance, the compressing module 430 may add pruning operations to DNN layers to reduce computational complexity or memory usage. A pruning operation may prune weight tensors of a DNN layer by changing one or more nonzero valued weights of the layer to zeros. The modification may be done before, during, or after training. Weights may be pruned during training, during inference, or a combination of both. The compressing module 430 may determine a sparsity ratio for a DNN layer. The sparsity ratio may be a ratio of the number of zero-valued weight to the total number of weights in the layer. The compressing module 430 may perform the pruning operation till the sparsity ratio of the DNN layer meets a target sparsity ration, such as 10%, 20%, 30%, 40%, 50%, and so on.

In some embodiments, the compressing module 430 may select one or more layers in a DNN and modify each selected layer with a pruning operation. For instance, the compressing module 430 may select computationally complex layers, such as layers with large filters. For a pruning operation of a layer or of a type of layer, the compressing module 430 may determine a weight threshold that would not cause a loss of the accuracy of the DNN to exceed an accuracy loss constraint. A pruning operation may modify weights having absolute values above the weight threshold to zeros and leave the other weights unchanged. The weight pruning can reduce memory storage as zero-valued weights may not be stored. Also, the number of operations in the layer can be reduced as computations on zero-valued weights can be skipped without impacting the output of the layer. In some embodiments, the compressing module 430 may also measure energy saving, final DNN accuracy, or layer-wise sparsity caused by pruning operations.

After compressing a DNN, the compressing module 430 may fine tune the DNN, e.g., through a retraining process. The compressing module 430 may fine tunes DNNs after weights are pruned. In some embodiments, the fine-tuning process is a retraining or further training process. For instance, after weights in a DNN are pruned, the compressing module 430 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the compressing module 430 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the compressing module 430, the compressing module 430 may perform a new pruning process, e.g., by selecting weight blocks and pruning the selected weight blocks. In some embodiments, the weight pruning process may be repeated multiple times before the fine-tuning process is done.

In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 4, 5, and so on.

The validating module 440 verifies accuracy of trained or compressed DNNs. In some embodiments, the validating module 440 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 440 may determine an accuracy score measuring the precision, recall, or a combination of precision and recall of the DNN. The validating module 440 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 440 may compare the accuracy score with a threshold score. In an example where the validating module 440 determines that the accuracy score of the augmented model is less than the threshold score, the validating module 440 instructs the training module 420 to re-train the DNN. In one embodiment, the training module 420 may iteratively re-train the DNN until the occurrence of a stopping condition, such as the accuracy measurement indication that the DNN may be sufficiently accurate, or a number of training rounds having taken place.

The sparsity mode module 450 configures sparsity modes of DNN accelerators, such as the DNN accelerator 302. In some embodiments, the sparsity mode module 450 may determine operation modes for load modules in DNN accelerators, such as the load module 350. For instance, the sparsity mode module 450 may select between an activation sparsity mode and a weight sparsity mode for a load module. The sparsity mode module 450 may select one sparsity mode for a single load cycle by the load module, e.g., a load cycle for loading data from a memory to a sparse cell array to perform a deep learning operation. The sparsity mode module 450 may select different sparsity modes for different load cycles by the load module, such as different load cycles for performing different deep learning operations.

To select between the activation sparsity mode and weight sparsity mode, the sparsity mode module 450 may evaluate sparsity in weights or sparsity in activations. To evaluate sparsity in weights, the sparsity mode module 450 may determine a sparsity ratio in a weight tensor of the corresponding deep learning operation or corresponding DNN layer. The weight tensor may be one or more filters, such as filters 220 in FIG. 2. In an example, the sparsity mode module 450 may determine whether the sparsity ratio meets a threshold, such as 40%, 50%, and so on. In response to a determination that the sparsity ratio meets the threshold, the sparsity mode module 450 may select the weight sparsity mode or perform other evaluations. In another example, the sparsity mode module 450 may determine whether the DNN training process incorporates structured sparsity, e.g., whether the DNN training process includes a pruning operation for structured sparsity. In response to a determination that there is structured sparsity in the training process, the sparsity mode module 450 may select the weight sparsity mode or perform other evaluations.

The sparsity mode module 450 may evaluate sparsity in weights offline, e.g., before DNN execution starts, as values of the weights can be known before execution. The sparsity mode module 450 may evaluate sparsity in activations offline, online (i.e., during runtime), or both. For instance, the sparsity mode module 450 may evaluate sparsity in activations offline by determining whether the activations are generated based on a sparsity-introducing activation function, such as ReLU. In response to a determination that the activations are generated based on a sparsity-introducing activation function, the sparsity mode module 450 may select the activation sparsity mode or perform other evaluations. To evaluate sparsity in activation during runtime (e.g., during execution), the sparsity mode module 450 may measure the sparsity ratio of the activations and determine whether the sparsity ratio meets a threshold. In response to a determination that the sparsity ratio meets the threshold, the sparsity mode module 450 may select the weight sparsity mode or perform other evaluations.

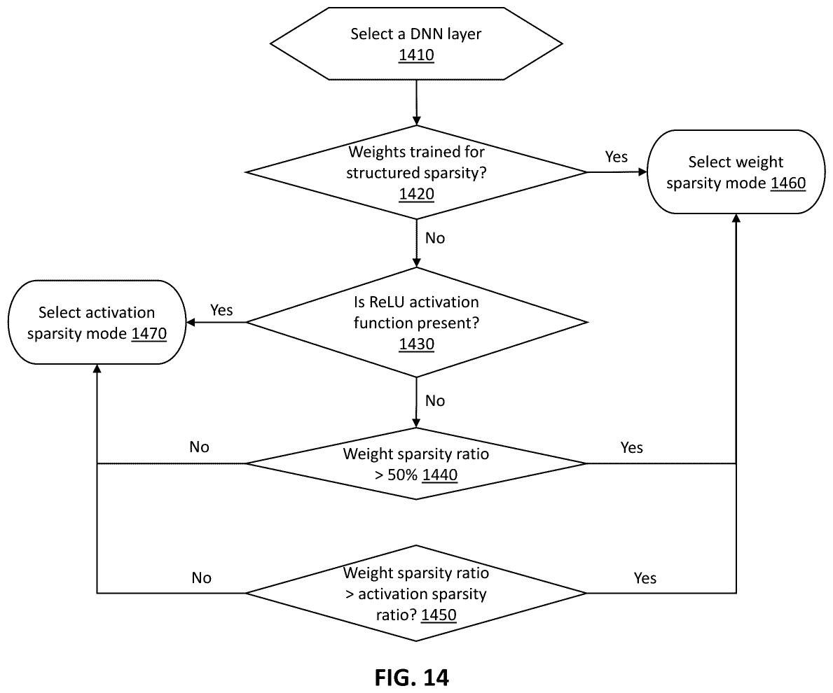

The evaluations described above are examples. The sparsity mode module 450 may perform fewer, more, or different evaluations of sparsity in weights or activations. In some embodiments, the sparsity mode module 450 may perform evaluations in a sequence. The sparsity mode module 450 may select the sparsity mode based on a combination of the results of multiple evaluations. More details regarding selecting sparsity mode are described below in conjunction with FIG. 14. After the sparsity mode module 450 makes a selection, the sparsity mode module 450 may generate a configuration parameter that encodes the selection. For instance, the configuration parameter may have a value indicating that the activation sparsity mode is selected and a different value indicating that the weight sparsity mode is selected. The configuration parameter can be provided to DNN accelerators to configure operations of load modules in the DNN accelerator and enable switchable sparsity load in the DNN accelerators.

The datastore 460 stores data received, generated, used, or otherwise associated with the DNN module 400. For example, the datastore 460 stores the datasets used by the training module 420 and validating module 440. The datastore 460 may also store data generated by the training module 420 and validating module 440, such as the hyperparameters for training DNNs, internal parameters of trained DNNs (e.g., weights, etc.), data for sparsity acceleration (e.g., sparsity bitmap, etc.), and so on. The datastore 460 may store configuration parameters generated by the sparsity mode module 450. In the embodiment of FIG. 4, the datastore 460 is a component of the DNN module 400. In other embodiments, the datastore 460 may be external to the DNN module 400 and communicate with the DNN module 400 through a network.

Example Switchable One-Sided Sparsity Acceleration

FIG. 5 illustrates a load module 500 facilitating switchable one-sided sparsity acceleration, in accordance with various embodiments. The load module 500 may be an example of the load module 350 in FIG. 3. In the embodiments of FIG. 5, the load module 500 includes an activation load unit 510, a weight load unit 520, three multiplexers (MUXs) 530, 540, and 550, and a densification unit 533. In other embodiments, the load module 500 may include fewer, more, or different components. For instance, the load module 500 may include data transfer paths, which may be connected to the activation load unit 510, weight load unit 520, MUXs 530, 540, and 550, or densification unit 533.

The activation load unit 510 load activations and an activation sparsity tensor from a memory 505, as shown by the solid arrow between the memory 505 and the activation load unit 510. The memory 505 may be a local memory of a compute block, such as the local memory 340. The weight load unit 520 loads weights and a weight sparsity tensor from the memory 505, as shown by the dash arrow between the memory 505 and the weight load unit 520. The activations may be elements of an activation operand for one or more MAC operations, and the weights may be elements of a weight operand for one or more MAC operations. The activation sparsity tensor may be a sparsity tensor of the activation operand, and the weight sparsity tensor may be a sparsity tensor of the weight operand. In some embodiments, the activations and weights are nonzero valued.

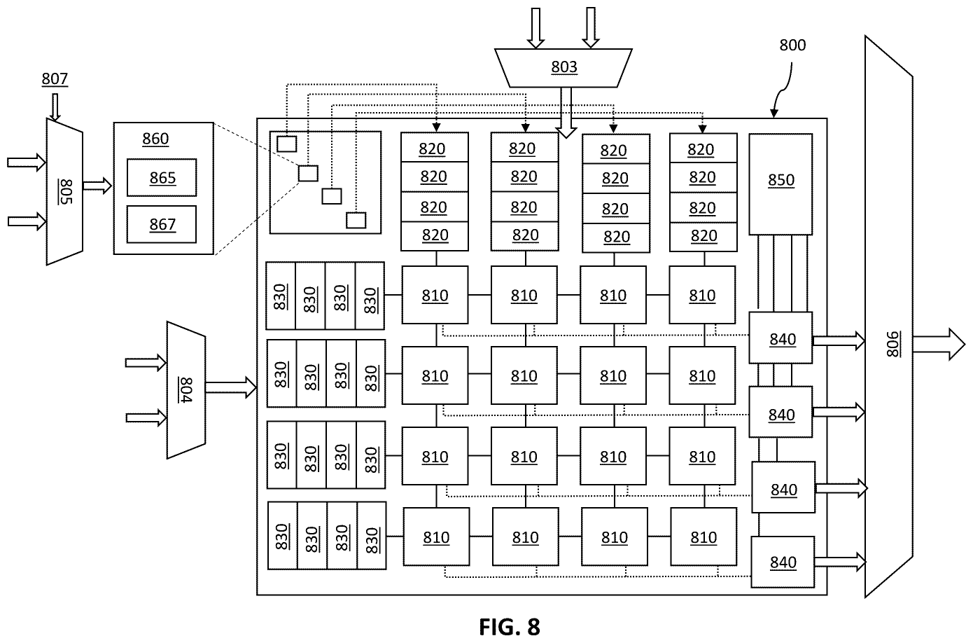

The activation load unit 510 transmits the activation and activation sparsity tensor to the MUX 530 and to the MUX 540. Similarly, the weight load unit 520 transmits the weights and weight sparsity tensor to both the MUX 530 and the MUX 540. The MUX 530 is coupled to a dense storage unit 535. The MUX 540 is coupled to a sparse storage unit 545. The dense storage unit 535 and sparse storage unit 545 may be storage units in a sparse cell, such as the sparse cell 800 in FIG. 8. The dense storage unit 535 may be designated for storing dense data, and the sparse storage unit 545 may be designated for storing sparse data. In some embodiments, the dense storage unit 535 or the sparse storage unit 545 may be one or more register files.

Operation of the MUXs 530, 540, and 550 may be controlled by a configuration parameter 503. The configuration parameter 503 can configure the operation mode of the MUXs 530 and 540 to either an activation sparsity mode or a weight sparsity mode. In embodiments where the configuration parameter 503 configures the operation mode of the MUXs 530, 540, and 550 to a weight sparsity mode, the MUX 530 would send the activations and activation sparsity tensor to the densification unit 533. The MUX 530 may discard the weights and weight sparsity tensor. The densification unit 533 may generate a dense activation tensor that includes the activations and one or more zeros based on the activation sparsity tensor. The densification unit 533 may determine positions or indexes of the activations and zeros in the dense activation tensor based on the activation sparsity tensor. More details regarding densification are described below in conjunction with FIG. 6. The dense activation tensor is written into the dense storage unit 535. The MUX 540 forwards the weights to the sparse storage unit 545 where the weights are stored as a sparse weight tensor. Also, the MUX 550 may receive the activation sparsity tensor and the weight sparsity tensor from the activation load unit 510 and the weight load unit 520, respectively. In the weight sparsity mode, the MUX 550 transmits the weight sparsity tensor to a sparsity tensor storage unit 560 that stores the weight sparsity tensor. The MUX 550 may discard the activation sparsity tensor. The sparsity tensor storage unit 560 may be in the sparse cell including the dense storage unit 535 and the sparse storage unit 545. That way, the weight sparsity tensor, dense activation tensor, and sparse weight tensor may be used by the sparse cell to perform MAC operations.

In embodiments where the configuration parameter 503 configures the operation mode of the MUXs 530, 540, and 550 to an activation sparsity mode, the MUX 530 would send the weights and weight sparsity tensor to the densification unit 533. The MUX 530 may discard the activations and activation sparsity tensor. The densification unit 533 may generate, based on the weight sparsity tensor, a dense weight tensor that includes the weights and one or more zeros. The densification unit 533 may determine positions or indexes of the weights and zeros in the dense weight tensor based on the weight sparsity tensor. More details regarding densification are described below in conjunction with FIG. 6. The dense weight tensor is written into the dense storage unit 535. The MUX 540 forwards the activations to the sparse storage unit 545 where the activations are stored as a sparse activation tensor. Also, the MUX 550 may receive the activation sparsity tensor and the weight sparsity tensor from the activation load unit 510 and the weight load unit 520, respectively. In the activation sparsity mode, the MUX 550 transmits the activation sparsity tensor to a sparsity tensor storage unit 560 that stores the activation sparsity tensor. The MUX 550 may discard the weight sparsity tensor. The sparsity tensor storage unit 560 may be in the sparse cell including the dense storage unit 535 and the sparse storage unit 545. That way, the activation sparsity tensor, dense weight tensor, and sparse activation tensor may be used by the sparse cell to perform MAC operations.

FIG. 6 illustrates a densification process, in accordance with various embodiments. The densification process may be performed by a densification unit in a load module, e.g., the densification unit 533 in FIG. 5. The densification unit 533 receives a sparsity bitmap 610 and a sparse tensor 615. For the purpose of simplicity and illustration, FIG. 6 shows seven sparsity elements of the sparsity bitmap 610 (0, 1, 0, 1, 0, 1, and 0) and shows four data elements of the sparse tensor 615, each data element has two bytes. In some embodiments, the sparsity bitmap 610 is an activation sparsity tensor, and the sparse tensor 615 is an activation sparse tensor. In other embodiments, the sparsity bitmap 610 is a weight sparsity tensor, and the sparse tensor 615 is a weight sparse tensor.

The densification unit 533 densifies the sparse tensor 615 based on the sparsity bitmap 610 and generates a dense tensor 625. In the embodiments of FIG. 6, each sparsity element having a value of one corresponds to a data element in the sparse tensor 615. Each sparsity element having a value of zero does not correspond to any data element in the sparse tensor 615. To generate the dense tensor 625, the densification unit 533 added four zeros into the sparse tensor 615. The added zeros are represented by the shaded shapes in FIG. 6. Each of these zeros corresponds to a sparsity element having a value of zero in the sparse tensor 615.

The dense tensor 625 has the same number of elements as the sparsity bitmap 610. Each zero-valued sparsity elements of the sparsity bitmap 610 corresponds to a respective zero-valued data element of the dense tensor 625. The position/index of the zero-valued sparsity element in the sparsity bitmap 610 is the same as the position/index of the valued data element in the dense tensor 625. The densification unit 533 may determine positions of the inserted zeros in the dense tensor 625 based on the sparsity bitmap 610. The dense tensor 625 has a new sparsity bitmap 620. All elements of the sparsity bitmap 620 are ones as there is no sparsity in the dense tensor 625.

FIG. 7 illustrates sparsity acceleration in an MAC operation by a PE 700, in accordance with various embodiments. The PE 700 may be a unit component of a sparse cell. In the embodiments of FIG. 7, the PE 700 includes a dense register file 710, a sparse register file 720, a multiplier 730, an accumulator 740, and an output register file 750. In other embodiments, the PE 700 may include fewer, more, or different components. The multiplier 730 and accumulator 740 may constitute an MAC unit. The dense register file 710 may be a dense storage unit or part of a dense storage unit in the sparse cell, e.g., the dense storage unit 535 in FIG. 5. The sparse register file 720 may be a sparse storage unit or part of a sparse storage unit in the sparse cell, e.g., the sparse storage unit 545 in FIG. 5. The output register file 750 may be, or may be part of, another dense storage unit in the sparse cell. The PE 700 is associated with a sparsity accelerator 760.

The dense register file 710 stores a dense operand, such as a dense activation operand or a dense weight operand. The sparse register file 720 stores a sparse operand, such as a sparse weight operand or a sparse activation operand. The sparsity accelerator 760 receives a sparsity bitmap 715 that corresponds to the sparse tensor in the sparse register file 720. For instance, when the sparse tensor is a sparse weight tensor, the sparsity bitmap 715 may be a weight sparsity bitmap; when the sparse tensor is a sparse activation tensor, the sparsity bitmap 715 maybe an activation sparsity bitmap. The sparsity bitmap 715 may have the same size (e.g., the same number of elements) as the dense tensor stored in the dense register file 710. The size of the sparse tensor may equal the number of nonzero valued elements of the sparsity bitmap 715. In the embodiments of FIG. 7, the size of the sparse tensor is four, and the size of the dense tensor is eight.

The sparsity accelerator 760 selects four of the eight data elements of the dense tensor and provides the selected four data elements to the multiplier 730. These selected data elements correspond to the nonzero valued elements of the sparsity bitmap 715. In the embodiments of FIG. 7, the first, third, sixth, and eighth element of the dense tensor are selected. Also, all the elements of the sparse tensor are provided to the multiplier 730. The four elements of the dense tensor and the four elements of the sparse tensor may constitute four activation-weight pairs. The multiplier 730 may compute a product based on each activation-weight pair and therefore, compute four products in total. The four products may be provided to the accumulator 740. Even though FIG. 7 shows a single multiplier 730, the PE 700 may include multiple multipliers that can perform multiple multiplication operations at the same time.

The accumulator 740 accumulates the four products and computes a PE-level internal partial sum. The four unselected elements of the dense tensor are not processed to save power and time, which would not impact the value of the PE-level internal partial sum. For instance, when the dense tensor is a dense activation tensor, the weights corresponding to the unselected activations are zeros so the products of the unselected activations and the weights would all be zero and have no contribution to the PE-level internal partial sum or other partial sums computed by the sparse cell. Similarly, when the dense tensor is a dense weight tensor, the activations corresponding to the unselected weights are zeros so the products of the unselected weights and the activations would all be zero and have no contribution to the PE-level internal partial sum or other partial sums computed by the sparse cell.

The PE-level internal partial sum may be stored in the output register file 750. In some embodiments, the accumulator 740 receives one or more PE-level internal partial sums from one or more other PEs. The accumulator 740 can accumulate the one or more PE-level internal partial sums with the PE-level internal partial sum of the PE 700 and store the result of the accumulation (i.e., a multi-PE internal partial sum) in the output register file 750. The one or more other PEs may be in the same column as the PE 700 in a PE array. The multi-PE internal partial sum may be a column-level internal partial sum. In some embodiments, the PE-level internal partial sum of the PE 700 or the multi-PE internal partial sum may be sent to one or more other PEs for further accumulation.

FIG. 8 illustrates a sparse cell 800, in accordance with various embodiments. The sparse cell 800 may be in a sparse cell array, e.g., the sparse cell array 360 in FIG. 1. The sparse cell 800 includes 16 MAC units 810 (individually referred to as “MAC unit 810”) arranged in four rows and four columns, 16 dense register files 820 (individually referred to as “dense register file 820”), 16 sparse register files 830 (individually referred to as “sparse register file 830”), four row buffers 840 (individually referred to as “row buffer 840”), a transpose module 850, and four sparsity modules 860 (individually referred to as “sparsity module 860”). In other embodiments, the sparse cell 800 may include fewer, more, or different components. For instance, the sparse cell may include a different number of MAC units 810, dense register files 820, sparse register files 830, row buffers 840, or sparsity modules 860.

The MAC units 810 are configured to perform MAC operations. Each MAC unit 810 may include one or more multipliers and one or more accumulators. An example of the multipliers may be the multiplier 730 in FIG. 7. A multiplier may multiply an activation with a weight at a time to compute a product. In some embodiments (e.g., embodiments where the MAC unit 810 includes multiple multipliers), the multipliers may operate simultaneously to process multiple activation-weight pairs and compute multiple products in one cycle. An accumulator may accumulate products computed by the multipliers. Even though not shown in FIG. 8, the sparse cell may include an adder tree including a plurality of adder tiers. The first tier may receive outputs of a plurality of MAC units 810. The number of adders in the first tier may be half of the number of the MAC units 810, and each adder may accumulate the outputs of two MAC units 810. The second tier may receive outputs of adders in the first tier. The number of adders in the second tier may be half of the number of adders in the first tier, and each adder in the second tier may accumulate the outputs of two adders in the first tier. The adder tree may include one or more other tiers. The last tier may include a single accumulator that accumulates outputs of adders in the second last tier to compute a partial sum of the sparse cell 800.

The dense register files 820 store dense tensors (e.g., dense tensors described above) to be processed in MAC operations. In the embodiments of FIG. 8, four dense register files 820 are grouped into a storage set that stores data to be used by a column of MAC units 810. There are four storage sets corresponding to the four columns of MAC units 810. In some embodiments, a dense register file 820 may correspond to a MAC unit 810 and store data to be processed by the MAC unit. In some embodiments, all the 16 dense register files 820 constitute a dense storage unit. The dense register files 820 may store activations in embodiments where the sparse cell operates in a weight sparsity mode but store weights in embodiments where the sparse cell operates in an activation sparsity mode.

The sparse register files 830 store sparse tensors (e.g., sparse tensors described above) to be processed in MAC operations. In the embodiments of FIG. 8, four sparse register files 830 are grouped into a storage set that stores data to be used by a row of MAC units 810. There are four storage sets corresponding to the four rows of MAC units 810. In some embodiments, a sparse register file 830 may correspond to a MAC unit 810 and store data to be processed by the MAC unit. In some embodiments, all the 16 sparse register files 830 constitute a sparse storage unit. The dense register files 820 may store activations in embodiments where the sparse cell operates in an activation sparsity mode but store weights in embodiments where the sparse cell operates in a weight sparsity mode.

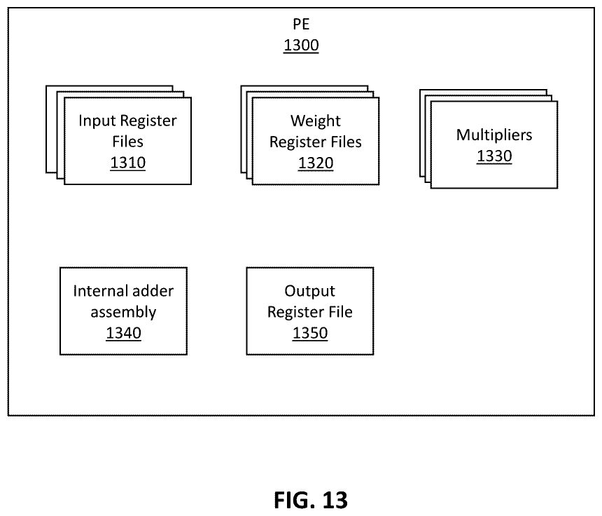

The row buffers 840 store outputs of the MAC units 810. Each row buffer 840 may drain outputs of a single row of MAC units 810. Data stored in the row buffers 840, such as output operands, may be further transmitted to the transpose module 850. The transpose module 850 may operate in either an activation sparsity mode or a weight sparsity mode. In some embodiments, the transpose module 850 may transpose the output operands in one of the two sparsity modes and keep the output operands as is in the other sparsity mode. More details regarding transposing output operands are described below in conjunction with FIG. 13.

The sparsity module 860 facilitates switchable one-sided sparsity acceleration in the sparse cell 800. An example of a sparsity module 860 is the sparsity accelerator 760 in FIG. 7. In the embodiments of FIG. 8, each sparsity module 860 includes a sparsity tensor storage unit 865 and a control logic 867. The sparsity tensor storage unit 865 stores sparsity tensors. A sparsity tensor stored in the sparsity tensor storage unit 865 may correspond to a sparse tensor stored in one or more sparse registered files 830. The sparsity tensor may be an activation sparsity tensor or weight sparsity tensor, depending on which side the sparsity acceleration is.

The control logic 867 may control transmission of activations and weights stored from the dense registered files 820 and the sparse registered files 830 to the MAC units 810 based on sparsity tensors. For instance, the control logic 867 may select a subset of the data elements stored in the dense registered files 820 based on a sparsity tensor and transmits the selected data elements to the MAC units 810 for computation. The other data elements stored in the dense registered files 820 are skipped from computation.

In the embodiments of FIG. 8, each sparsity module 860 controls sparsity acceleration in a respective column of MAC units 810. The MAC units 810 in the column may process the same sparse tensor but different dense tensors (or the same dense tensor but different sparse tensors) in a single computation round. As the sparsity acceleration is either based on weight or activation (but not both), four sparsity modules 860 can be sufficient for the 16 MAC units 810. For two-sided sparsity acceleration, the 16 MAC units 810 would need 16 sparsity modules 860 as the sparsity acceleration would be based on both the activation sparsity tensor and weight sparsity tensor, so even though the MAC units 810 in the same column process the same dense tensor (or sparse tensor), the sparsity acceleration would be different because the MAC units 810 processes different sparse tensors (or different dense tensors). Therefore, compared with two-sided sparsity acceleration, one-sided sparsity acceleration would consume less area and power.

As shown in FIG. 8, the sparse cell 800 is associated with MUXs 803, 804, 805, and 806. In other embodiments, the sparse cell 800 may be associated with a different number of MUXs or other devices. The MUX 803 facilitates loading activations or weights, e.g., from the local memory 340, into the dense registered files 820. An example of the MUX 803 may be the MUX 530 in FIG. 5. The MUX 804 facilitates loading activations or weights, e.g., from the local memory 340, into the sparse registered files 830. An example of the MUX 804 may be the MUX 540 in FIG. 5. The MUX 805 facilitates loading sparsity tensors into the sparsity tensor storage unit 865. An example of the MUX 805 may be the MUX 550 in FIG. 5. The MUX 806 may be a drain MUX that can facilitate draining outputs of the MAC units 810, e.g., to the local memory 340.

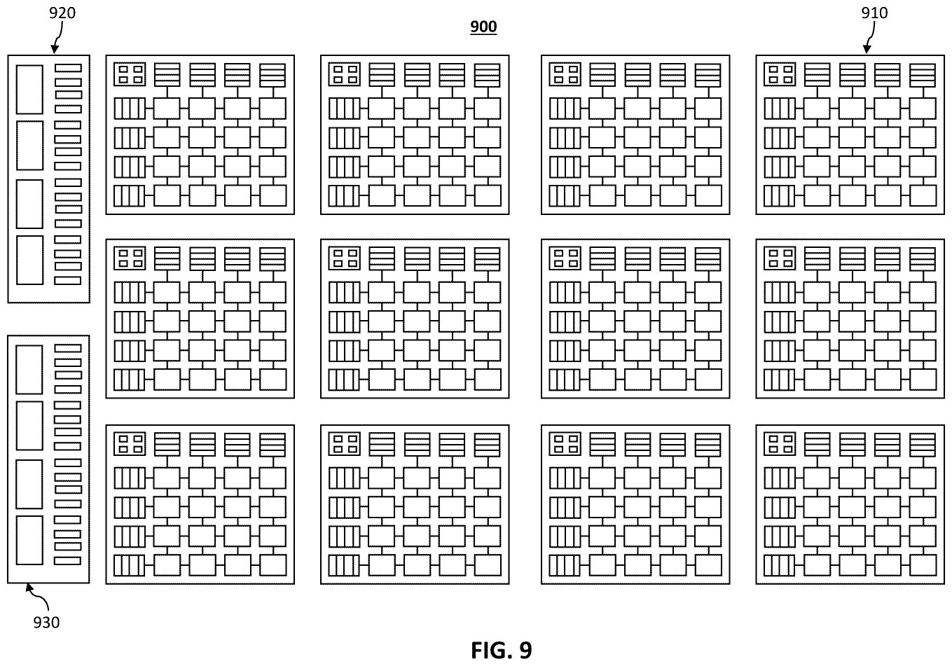

FIG. 9 illustrates a sparse cell array 900, in accordance with various embodiments. The sparse cell array 900 may be an example of the sparse cell array 360 in FIG. 3. In FIG. 9, the sparse cell array 900 includes sparse cells 910 (individually referred to as “sparse cell 910”) arranged in four columns and four rows, an activation memory 920, and a weight memory 930. In other embodiments, the sparse cell array 900 may include fewer, more, or different components. For instance, the sparse cell array 900 may include a different number of columns, rows, or sparse cells 910.

Each sparse cell may perform one-side sparsity accelerated MAC operations. An embodiment of a sparse cell 910 may be the sparse cell 800 in FIG. 8. The activation memory 920 stores activations, such as activations in input tensors of deep learning operations. Activations may be loaded from the activation memory 920 to sparse cells 910. The weight memory 930 stores weights, such as weights in filters of deep learning operations. Weights may be loaded from the weight memory 930 to sparse cells 910. The activation memory 920 or weight memory 930 may be a buffer. In other embodiments, the sparse cell array 900 may include a dense data memory and a sparse data memory in lieu of the activation memory 920 and weight memory 930. The dense data memory may store dense tensors, e.g., dense tensors generated by the load module 350. The sparse data memory may store sparse tensors.

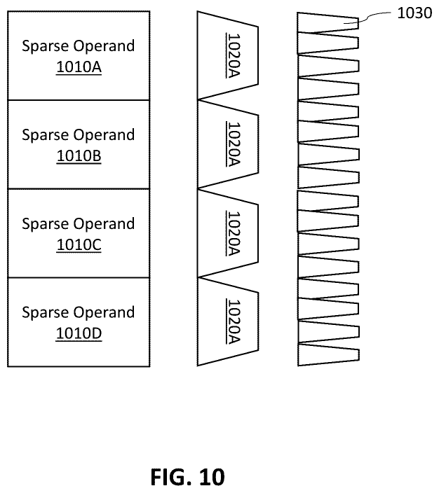

FIG. 10 illustrates read ports 1030 for reading sparse operands 1110A-1110D for two-sided sparsity acceleration, in accordance with various embodiments. The sparse operands 1110A-1110D are collectively referred to as “sparse operands 1110” or “sparse operand 1110.” Each sparse operand may include nonzero-valued elements and does not include any zero-valued elements. A sparse operand may be an input to one or more MAC units (e.g., the MAC units 810) for MAC operations. The sparse operands 1110 are provided to MUXs 1020A-1020D, collectively referred to as “MUXs 1020” or “MUX 1020.” Each MUX 1020 may receive a different sparse operand 1010. An example of a MUX 1020 may be a 64:16 MUX.

In some embodiments, a MUX 1020 may correspond to a column of MAC units in a sparse cell. In the embodiments of FIG. 10, each column has four MAC units. In other embodiments, a column may have a different number of MAC units. As the sparsity acceleration is two-sided, the MAC units in the column would process different data elements. To support the two-sided sparsity acceleration, each MUX 1020 may direct the corresponding sparse operand 1010 to four read ports 1030 (individually referred to as a “read port 1030”). A read port 1030 may correspond to a different MAC unit in the column and may facilitate transmission of data elements in the sparse operand 1010 to the MAC units. In the embodiments of FIG. 10, as there are four sparse operands 1010 for four columns of MAC units, the total number of read ports 1030 is 16.

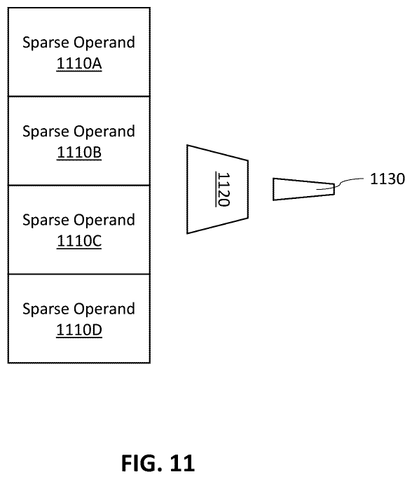

FIG. 11 illustrates one read port 1130 for reading sparse operands 1110A-1110D for one-sided sparsity acceleration, in accordance with various embodiments. Similar to FIG. 10, FIG. 11 also illustrates load of four sparse operands 1110A-1110D to a column of four MAC units. Different from the embodiments of FIG. 10, the embodiment of FIG. 11 use a single MUX 1120 and a single read port 1130 to direct the sparse operands 1110A-1110D to MAC units. The MUX 1120 may be the same or similar as each MUX 1020 in FIG. 10. In an example, the MUX 1120 may be a 64:16 MUX. As the sparsity acceleration in the embodiment of FIG. 11 is one-sided, all the MAC units in the column may move in lockstep as each MAC unit would process a sparse operand 1110 plus a dense operand. With one side being dense, the MAC units in the column can progress potentially in lockstep with all the MAC units requiring accessing a single sparse operand 1110. Accordingly, a single read port 1130 would be sufficient to load the sparse operands 1110 to the column. Therefore, compared with two-sided sparsity acceleration, one-sided sparsity acceleration can result in significant reduction in MUXs and read ports.

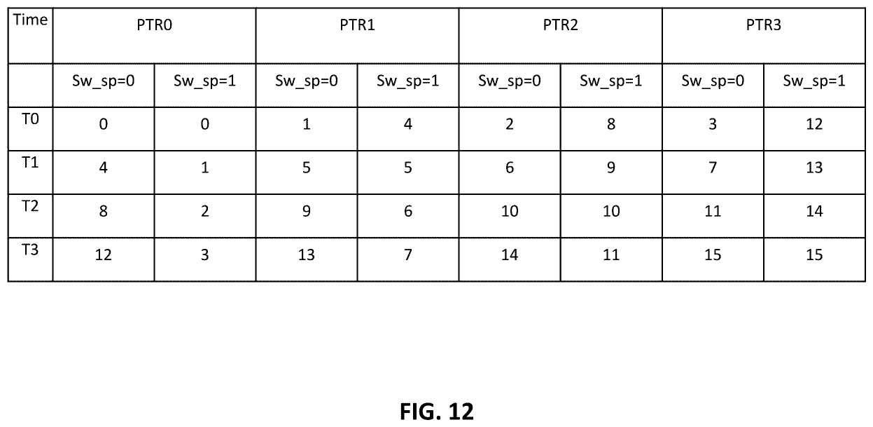

FIG. 12 illustrates a data drain approach for facilitating switchable one-sided sparsity acceleration, in accordance with various embodiments. For the purpose of simplicity and illustration, in the embodiments of FIG. 12, outputs of 16 MAC units (shown as 0-15 in FIG. 12) are drained using four pointers (shown as PTR0-PTR4 in FIG. 12) at different times (shown as T0-T3 in FIG. 12). The 16 MAC units may be in a sparse cell. The MAC units may be arranged in four rows: a first row including MAC units 0-3, a second row including MAC units 4-7, a third row including MAC units 8-11, and a fourth row including row including MAC units 12-15. The MAC units are also in four columns: a first column including MAC units 0, 4, 8, and 12; a second column including MAC units 1, 5, 9, and 13; a third column including MAC units 2, 6, 10, and 14; and a fourth column including MAC units 3, 7, 11, and 15.

The sequence in which the outputs of the MAC units are drained is dependent on the sparsity mode, which is indicated by a configuration parameter (shown as Sw-sp in FIG. 12). When the configuration parameter has a value of 0, data is drained with a row granularity. As shown in FIG. 12, outputs of the MAC units 0-3 in the first row are drained at T0 by PTR0-3, respectively. Then the outputs of the MAC units 4-7 in the second row are drained at T1 by PTR0-3. The outputs of the MAC units 8-11 in the second row are drained at T2 by PTR0-3. The outputs of the MAC units 12-15 in the second row are drained at T3 by PTR0-3.

When the configuration parameter has a value of 0, data is drained with a column granularity. As shown in FIG. 12, outputs of the MAC units 0, 4, 8, and 12 in the first column are drained at TO by PTR0-3, respectively. Then the outputs of the MAC units 1, 5, 9, and 13 in the second column are drained at T1 by PTR0-3. The outputs of the MAC units 2, 6, 10, and 14 in the second column are drained at T2 by PTR0-3. The outputs of the MAC units 3, 7, 11, and 15 in the second column are drained at T3 by PTR0-3.

For two-sided sparsity acceleration, the MAC units in each sparse cell may be drained with row-wise granularity. The pointer that selects the MAC row may have values of 0, 1, 2, 3 (1×2-bit pointer). For switchable one-sided sparsity acceleration, 4 MAC units may be selected depending on the sparsity mode, so the selection may be on a MAC unit level, as opposed to a row level. In the embodiments of FIG. 12, this selection is implemented using 4×4-bit pointers (i.e., PTR0-PTR3) where each pointer selects one MAC unit at a time, and the selected MAC units may be in the same column but in different rows. The selection of MAC units may be transposed from row to column for one of the two sparsity modes.

Additionally or alternatively, the output tensor may be transposed. For instance, the MAC units may be selected and drained with row-wise granularity for both activation sparsity mode and weight sparsity mode. In one of the two sparsity modes, the drained output tensor may be transposed by converting rows to columns or columns to rows.

### Example PE

FIG. 13 is a block diagram of a PE 1300, in accordance with various embodiments. The PE 1300 may be an embodiment of the PE 700 in FIG. 7. The PE 1300 may perform MAC operations, e.g., MAC operations using data in integer formats. As shown in FIG. 13, the PE 1300 includes input register files 1310 (individually referred to as “input register file 1310”), weight register files 1320 (individually referred to as “weight register file 1320”), multipliers 1330 (individually referred to as “multiplier 1330”), an internal adder assembly 1340, and an output register file 1350. In other embodiments, the PE 1300 may include fewer, more, or different components. For example, the PE 1300 may include multiple output register files 1350. As another example, the PE 1300 may include a single input register file 1310, weight register file 1320, or multiplier 1330. As yet another example, the PE 1300 may include an adder in lieu of the internal adder assembly 1340. Also, the PE 1300 may include dense register files and sparse register files in lieu of the input register files 1310 and the weight register files 1320.

The input register files 1310 temporarily store input operands for MAC operations by the PE 1300. In some embodiments, an input register file 1310 may store a single input operand at a time. In other embodiments, an input register file 1310 may store multiple input operand or a portion of an input operand at a time. An input operand includes a plurality of input elements (i.e., input elements) in an input tensor. The input elements of an input operand may be stored sequentially in the input register file 1310 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same (X, Y) coordinates, which may be used as the (X, Y) coordinates of the input operand. For instance, all the input elements of an input operand may be X0Y0, X0Y1, X1Y1, etc.

The weight register file 1320 temporarily stores weight operands for MAC operations by the PE 1300. The weight operands include weights in the filters of the DNN layer. In some embodiments, the weight register file 1320 may store a single weight operand at a time. other embodiments, an input register file 1310 may store multiple weight operands or a portion of a weight operand at a time. A weight operand may include a plurality of weights. The weights of a weight operand may be stored sequentially in the weight register file 1320 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 1320 may be the same or similar as an input register file 1310, e.g., having the same size, etc. The PE 1300 may include a plurality of register files, some of which are designated as the input register files 1310 for storing input operands, some of which are designated as the weight register files 1320 for storing weight operands, and some of which are designated as the output register file 1350 for storing output operands. In other embodiments, register files in the PE 1300 may be designated for other purposes, e.g., for storing scale operands used in elementwise add operations, etc.

The multipliers 1330 perform multiplication operations on input operands and weight operands. A multiplier 1330 may perform a sequence of multiplication operations on a single input operand and a single weight operand and generate a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 1330 may perform multiplication operations simultaneously. These multiplication operations may be referred to as a round of multiplication operations. In a round of multiplication operations by the multipliers 1330, each of the multipliers 1330 may use a different input operand and a different weight operand. The different input operands or weight operands may be stored in different register files of the PE 1300. For instance, a first multiplier 1330 uses a first input operand (e.g., stored in a first input register file 1310) and a first weight operand (e.g., stored in a first weight register file 1320), versus a second multiplier 1330 uses a second input operand (e.g., stored in a second input register file 1310) and a second weight operand (e.g., stored in a second weight register file 1320), a third multiplier 1330 uses a third input operand (e.g., stored in a third input register file 1310) and a third weight operand (e.g., stored in a third weight register file 1320), and so on. For an individual multiplier 1330, the round of multiplication operations may include a plurality of cycles. A cycle includes a multiplication operation on an input element and a weight.

The multipliers 1330 may perform multiple rounds of multiplication operations. A multiplier 1330 may use the same weight operand but different input operands in different rounds. For instance, the multiplier 1330 performs a sequence of multiplication operations on a first input operand stored in a first input register file in a first round, versus a second input operand stored in a second input register file in a second round. In the second round, a different multiplier 1330 may use the first input operand and a different weight operand to perform another sequence of multiplication operations. That way, the first input operand is reused in the second round. The first input operand may be further reused in additional rounds, e.g., by additional multipliers 1330.

The internal adder assembly 1340 includes one or more adders inside the PE 1300, i.e., internal adders. The internal adder assembly 1340 may perform accumulation operations on two or more products operands from multipliers 1330 and produce an output operand of the PE 1300. In some embodiments, the internal adders are arranged in a sequence of tiers. A tier includes one or more internal adders. For the first tier of the internal adder assembly 1340, an internal adder may receive product operands from two or more multipliers 1330 and generate a sum operand through a sequence of accumulation operations. Each accumulation operation produces a sum of two or more products, each of which is from a different multiplier 1330. The sum operand includes a sequence of sums, each of which is a result of an accumulation operation and corresponds to a depthwise channel. For the other tier(s) of the internal adder assembly 1340, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 1340 may include a single internal adder, which produces the output operand of the PE 1300.

The output register file 1350 stores output operands of the PE 1300. In some embodiments, the output register file 1350 may store an output operand at a time. In other embodiments, the output register file 1350 may store multiple output operands or a portion of an output operand at a time. An output operand includes a plurality of output elements in an IFM. The output elements of an output operand may be stored sequentially in the output register file 1350 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

Example Method of Selecting Sparsity Mode

FIG. 14 is a flowchart showing a method 1400 of selecting sparsity mode, in accordance with various embodiments. The method 1400 may be performed by the sparsity mode module 450 in FIG. 4. The method 1400 in FIG. 14 includes Steps 1410, 1420, 1430, 1440, 1450, 1460, and 1470. Although the method 1400 is described with reference to the flowchart illustrated in FIG. 14, many other methods for selecting sparsity mode may alternatively be used. For example, the order of execution of the steps in FIG. 14 may be changed. As another example, some of the steps may be changed, eliminated, or combined.

The sparsity mode module 450 selects a DNN layer in Step 1410. In some embodiments, the DNN layer may be a convolutional layer, such as the convolutional layers 110 in FIG. 1. The sparsity mode module 450 may select a DNN layer, the computation in which can be accelerated based on sparsity in activation or weights. For instance, the sparsity mode module 450 may select a DNN layer that has or is expected to have zero-valued activations or zero-valued weights.

After the DNN layer is selected, the sparsity mode module 450 determines weights of the selected DNN layer are trained for structured sparsity in Step 1420. In some embodiments, weights are trained for structured sparsity when the training of the DNN layer (or the training of the DNN) has a pruning operation, such as the pruning operations described above. In an example pruning operation, weights below a threshold value are pruned, i.e., modified to zeros.

In embodiments where the sparsity mode module 450 determines that the weights were trained for structured sparsity, the sparsity mode module 450 selects a weight sparsity mode in Step 1460. The sparsity mode module 450 may further generate a configuration parameter indicating the selection of the weight sparsity mode. The sparsity mode module 450 may provide the configuration parameter to a DNN accelerator (e.g., the DNN accelerator 302) that will execute the selected DNN layer (or the entire DNN). The DNN accelerator will operate in the weight sparsity mode for performing computations in the DNN layer and skip MAC operations in the DNN layer based on sparsity in weights.

In embodiments where the sparsity mode module 450 determines the weights of the selected DNN layer are not trained for structured sparsity, the sparsity mode module 450 determines whether a ReLU activation function is present in Step 1430. ReLU activation function can introduce sparsity to activations and increase sparsity ratio in the input tensor of the DNN layer. Alternatively, the sparsity mode module 450 may determine whether any sparsity-introducing activation function is present. The sparsity mode module 450 may determine whether a ReLU activation function (or any sparsity-introducing activation function) is arranged before the DNN layer in the DNN. For instance, the sparsity mode module 450 may determine whether a previous DNN layer has a ReLU activation function (or any sparsity-introducing activation function) as a post processing function or whether the input tensor of the selected DNN layer was generated based on a ReLU activation function (or any sparsity-introducing activation function).

In embodiments where the sparsity mode module 450 determines that there is a ReLU activation function (or one or more other sparsity-introducing activation functions), the sparsity mode module 450 selects an activation sparsity mode in Step 1470. The sparsity mode module 450 may further generate a configuration parameter indicating the selection of the activation sparsity mode. The sparsity mode module 450 may provide the configuration parameter to a DNN accelerator (e.g., the DNN accelerator 302) that will execute the selected DNN layer (or the entire DNN). The DNN accelerator will operate in the activation sparsity mode for performing computations in the DNN layer and skip MAC operations in the DNN layer based on sparsity in activations.

In embodiments where the sparsity mode module 450 determines that there is no ReLU activation function (or any sparsity-introducing activation function), the sparsity mode module 450 determines whether a weight sparsity ratio is greater than 50% in Step 1440. The weight sparsity ratio may be a percentage of zero-valued weights in all the weights of the selected DNN layer. A weight sparsity ratio of 50% means that half of the weights in the selected DNN layer are zero and the other half are nonzero.

In embodiments where the sparsity mode module 450 determines that the weight sparsity ratio is greater than 50%, the sparsity mode module 450 selects the weight sparsity mode in Step 1460. In embodiments where the sparsity mode module 450 determines that the weight sparsity ratio is equal to or smaller than 50%, the sparsity mode module 450 selects the activation sparsity mode in Step 1470.

The sparsity mode module 450 may perform the steps described above offline, e.g., before the DNN accelerator executes the DNN layer (or execute the entire DNN), as the weights and activation function can be known before DNN execution. In some embodiments, the sparsity mode module 450 may make further determinations during run time, e.g., during DNN execution. For instance, in Step 1470, the sparsity mode module 450 determines whether a weight sparsity ratio is greater than the activation sparsity ratio. The weight sparsity ratio in Step 1470 may be the same as the weight sparsity ratio in Step 1440. The activation sparsity ratio may be a percentage of zero-valued activations in the input tensor of the DNN layer. In embodiments where the sparsity mode module 450 determines that the weight sparsity ratio is greater than the activation sparsity ratio, the sparsity mode module 450 selects the weight sparsity mode in Step 1460. In embodiments where the sparsity mode module 450 determines that the weight sparsity ratio is no greater than the activation sparsity ratio, the sparsity mode module 450 selects the activation sparsity mode in Step 1470.

Example Method of Accelerating Deep Learning Operations

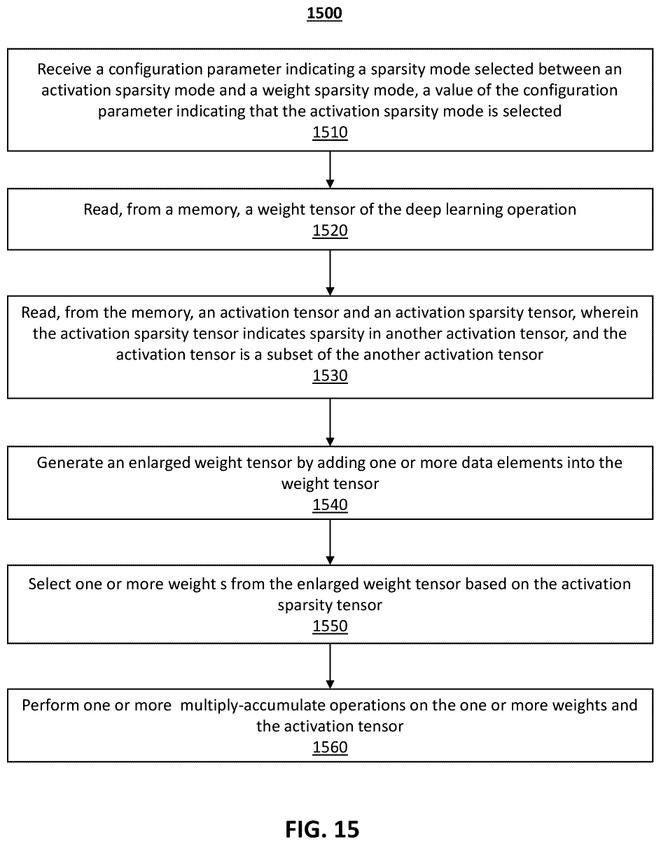

FIG. 15 is a flowchart showing a method 1500 of accelerating a deep learning operation, in accordance with various embodiments. The method 1500 may be performed by the DNN accelerator 302 in FIG. 3. Although the method 1500 is described with reference to the flowchart illustrated in FIG. 15, many other methods for accelerating deep learning operations may alternatively be used. For example, the order of execution of the steps in FIG. 15 may be changed. As another example, some of the steps may be changed, eliminated, or combined.

The DNN accelerator 302 receives 1510 a configuration parameter indicating a sparsity mode selected between an activation sparsity mode and a weight sparsity mode. A value of the configuration parameter indicating that the activation sparsity mode is selected. In some embodiments, the value of the configuration parameter is determined based on a sparsity ratio of a filter of the deep learning operations. The sparsity ratio indicates a ration of a number of nonzero valued weights in the filter to a total number of weights in the filter. Values of the weights in the filter are determined by training a neural network including the deep learning operation.

In some embodiments, the deep learning operation is an operation in a neural network. The value of the configuration parameter is determined by determining whether the deep learning operation is after an activation function in the neural network. In some embodiments, the deep learning operation is an operation in an execution process of a neural network. The value of the configuration parameters is determined before the execution process starts.

The DNN accelerator 302 reads 1520, from a memory, a weight tensor of the deep learning operation. The memory may be a local memory of a compute block in the DNN accelerator 302. In some embodiments, the memory is a SRAM.

The DNN accelerator 302 reads 1530, from the memory, an activation tensor and an activation sparsity tensor. The activation sparsity tensor indicates sparsity in another activation tensor. The activation tensor is a subset of the another activation tensor.

The DNN accelerator 302 generates 1540 an enlarged weight tensor by adding one or more data elements into the weight tensor. In some embodiments, the DNN accelerator 302 reads a weight sparsity tensor from the memory. The weight sparsity tensor comprises elements indicating sparsity in the enlarged weight tensor. The DNN accelerator 302 determines one or more positions of the one or more data elements in the enlarged weight tensor based on the weight sparsity tensor. The one or more data elements are added into the weight tensor based on the one or more positions.

The DNN accelerator 302 selects 1550 one or more weights from the enlarged weight tensor based on the activation sparsity tensor. The one or more weights may be paired with one or more activations that correspond to one or more elements of the activation sparsity tensor. The one or more elements of the activation sparsity tensor may indicate that the one or more activations are nonzero. The one or more activations may be the elements of the activation tensor.

The DNN accelerator 302 performs 1560 one or more multiply-accumulate operations on the one or more weights and the activation tensor. In some embodiments, the one or more multiply-accumulate operations are performed by one or more multiply-accumulate units that are arranged in a column comprising a plurality of multiply-accumulate units. The plurality of multiply-accumulate units performs multiply-accumulate operations based on the activation sparsity tensor.

In some embodiments, the DNN accelerator 302 stores the enlarged weight tensor in a first storage unit and stores the activation tensor in a second storage unit. The first storage unit may be a dense storage unit, such as the dense storage unit 535 in FIG. 5. The dense storage unit may include one or more dense register files (e.g., the dense register file 710 in FIG. 7, the dense register files 820 in FIG. 8, etc.). The second storage unit may be a sparse storage unit, such as the sparse storage unit 545 in FIG. 5. The sparse storage unit may include one or more sparse register files (e.g., the sparse register file 720 in FIG. 7, the sparse register files 830 in FIG. 8, etc.). The DNN accelerator 302 transmits the one or more weights from the first storage unit to one or more multiply-accumulate units. The DNN accelerator 302 further transmits the activation tensor from the second storage unit to the one or more multiply-accumulate units. The one or more multiply-accumulate operations are performed by the multiply-accumulate units.

In some embodiments, the DNN accelerator 302 determines, based on the configuration parameter, a sequence in which one or more outputs of the one or more multiply-accumulate operations are transmitted to the memory. In some embodiments, the one or more multiply-accumulate operations are performed by an array where a plurality of multiply-accumulate units is arranged in rows and columns. The DNN accelerator 302 may determine the sequence by performing, based on the value of the configuration parameter, a selection between a row index of a multiply-accumulate unit in the array and a column index of the multiply-accumulate unit in the array. The DNN accelerator 302 may determine an output of the multiply-accumulate unit is transmitted to the memory based on the selection.

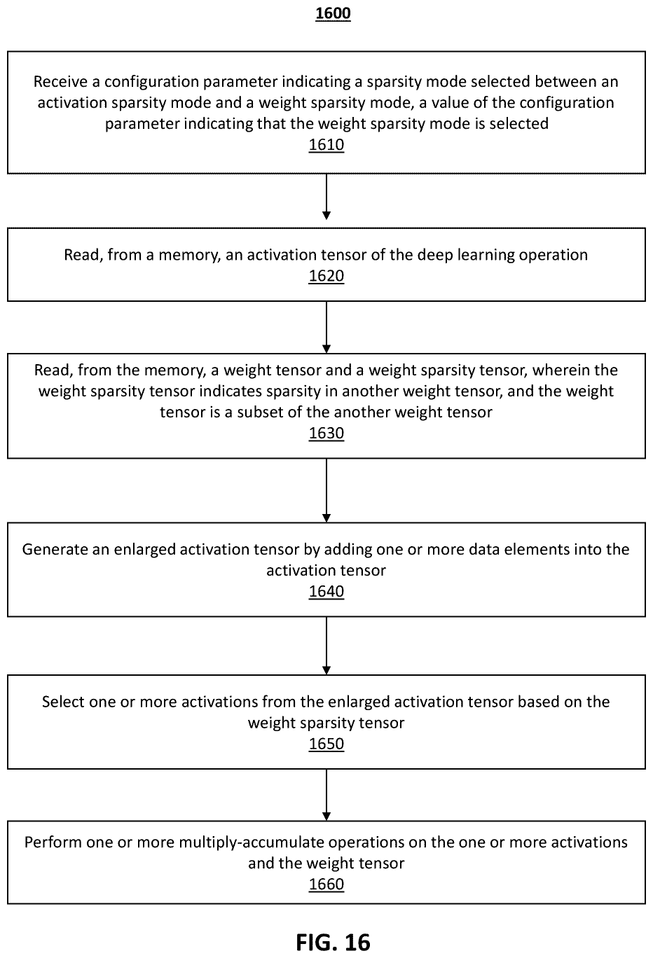

FIG. 16 is a flowchart showing another method 1600 of accelerating a deep learning operation, in accordance with various embodiments. The method 1600 may be performed by the DNN accelerator 302 in FIG. 3. Although the method 1600 is described with reference to the flowchart illustrated in FIG. 16, many other methods for accelerating deep learning operations may alternatively be used. For example, the order of execution of the steps in FIG. 16 may be changed. As another example, some of the steps may be changed, eliminated, or combined.

The DNN accelerator 302 receives 1610 a configuration parameter indicating a sparsity mode selected between an activation sparsity mode and a weight sparsity mode. A value of the configuration parameter indicating that the weight sparsity mode is selected. In some embodiments, the value of the configuration parameter is determined based on a sparsity ratio of a filter of the deep learning operations. The sparsity ratio indicates a ration of a number of nonzero valued weights in the filter to a total number of weights in the filter. Values of the weights in the filter are determined by training a neural network including the deep learning operation.

In some embodiments, the deep learning operation is an operation in a neural network. The value of the configuration parameter is determined by determining whether the deep learning operation is after an activation function in the neural network. In some embodiments, the deep learning operation is an operation in an execution process of a neural network. The value of the configuration parameters is determined before the execution process starts.

The DNN accelerator 302 reads 1620, from a memory, an activation tensor of the deep learning operation. The memory may be a local memory of a compute block in the DNN accelerator 302. In some embodiments, the memory is a SRAM.

The DNN accelerator 302 reads 1630, from the memory, a weight tensor and a weight sparsity tensor. The weight sparsity tensor indicates sparsity in another weight tensor. The weight tensor is a subset of the another weight tensor.

The DNN accelerator 302 generates 1640 an enlarged activation tensor by adding one or more data elements into the activation tensor. In some embodiments, the DNN accelerator 302 reads an activation sparsity tensor from the memory. The activation sparsity tensor comprises elements indicating sparsity in the enlarged activation tensor. The DNN accelerator 302 determines one or more positions of the one or more data elements in the enlarged activation tensor based on the activation sparsity tensor. The one or more data elements are added into the activation tensor based on the one or more positions.

The DNN accelerator 302 selects 1650 one or more activations from the enlarged activation tensor based on the weight sparsity tensor. The one or more activations may be paired with one or more weights that correspond to one or more elements of the weight sparsity tensor. The one or more elements of the weight sparsity tensor may indicate that the one or more weights are nonzero. The one or more weights may be the elements of the weight tensor.

The DNN accelerator 302 performs 1660 one or more multiply-accumulate operations on the one or more activations and the weight tensor. In some embodiments, the one or more multiply-accumulate operations are performed by one or more multiply-accumulate units that are arranged in a column comprising a plurality of multiply-accumulate units. The plurality of multiply-accumulate units performs multiply-accumulate operations based on the weight sparsity tensor.

In some embodiments, the DNN accelerator 302 stores the enlarged activation tensor in a first storage unit and stores the weight tensor in a second storage unit. The first storage unit may be a dense storage unit, such as the dense storage unit 535 in FIG. 5. The dense storage unit may include one or more dense register files (e.g., the dense register file 710 in FIG. 7, the dense register files 820 in FIG. 8, etc.). The second storage unit may be a sparse storage unit, such as the sparse storage unit 545 in FIG. 5. The sparse storage unit may include one or more sparse register files (e.g., the sparse register file 720 in FIG. 7, the sparse register files 830 in FIG. 8, etc.). The DNN accelerator 302 transmits the one or more activations from the first storage unit to one or more multiply-accumulate units. The DNN accelerator 302 further transmits the weight tensor from the second storage unit to the one or more multiply-accumulate units. The one or more multiply-accumulate operations are performed by the multiply-accumulate units.

In some embodiments, the DNN accelerator 302 determines, based on the configuration parameter, a sequence in which one or more outputs of the one or more multiply-accumulate operations are transmitted to the memory. In some embodiments, the one or more multiply-accumulate operations are performed by an array where a plurality of multiply-accumulate units is arranged in rows and columns. The DNN accelerator 302 may determine the sequence by performing, based on the value of the configuration parameter, a selection between a row index of a multiply-accumulate unit in the array and a column index of the multiply-accumulate unit in the array. The DNN accelerator 302 may determine an output of the multiply-accumulate unit is transmitted to the memory based on the selection.

Example Computing Device

FIG. 17 is a block diagram of an example computing device 1700, in accordance with various embodiments. In some embodiments, the computing device 1700 can be used as at least part of the DNN system 300. A number of components are illustrated in FIG. 17 as included in the computing device 1700, but any one or more of these components may be omitted or duplicated, as suitable for the application. In some embodiments, some or all of the components included in the computing device 1700 may be attached to one or more motherboards. In some embodiments, some or all of these components are fabricated onto a single system on a chip (SoC) die. Additionally, in various embodiments, the computing device 1700 may not include one or more of the components illustrated in FIG. 17, but the computing device 1700 may include interface circuitry for coupling to the one or more components. For example, the computing device 1700 may not include a display device 1706, but may include display device interface circuitry (e.g., a connector and driver circuitry) to which a display device 1706 may be coupled. In another set of examples, the computing device 1700 may not include an audio input device 1718 or an audio output device 1708, but may include audio input or output device interface circuitry (e.g., connectors and supporting circuitry) to which an audio input device 1718 or audio output device 1708 may be coupled.

The computing device 1700 may include a processing device 1702 (e.g., one or more processing devices). The processing device 1702 processes electronic data from registers and/or memory to transform that electronic data into other electronic data that may be stored in registers and/or memory. The computing device 1700 may include a memory 1704, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1704 may include memory that shares a die with the processing device 1702. In some embodiments, the memory 1704 includes one or more non-transitory computer-readable media storing instructions executable to perform operations for accelerating deep learning operations, e.g., the method 1600 described above in conjunction with FIG. 16, the method 1700 described above in conjunction with FIG. 17, or some operations performed by the DNN system 300 (e.g., described above in conjunction with FIG. 3. The instructions stored in the one or more non-transitory computer-readable media may be executed by the processing device 1702.

In some embodiments, the computing device 1700 may include a communication chip 1712 (e.g., one or more communication chips). For example, the communication chip 1712 may be configured for managing wireless communications for the transfer of data to and from the computing device 1700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1712 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1712 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1712 may operate in accordance with other wireless protocols in other embodiments. The computing device 1700 may include an antenna 1722 to facilitate wireless communications and/or to receive other wireless communications (such as AM or FM radio transmissions).

In some embodiments, the communication chip 1712 may manage wired communications, such as electrical, optical, or any other suitable communication protocols (e.g., the Ethernet). As noted above, the communication chip 1712 may include multiple communication chips. For instance, a first communication chip 1712 may be dedicated to shorter-range wireless communications such as Wi-Fi or Bluetooth, and a second communication chip 1712 may be dedicated to longer-range wireless communications such as global positioning system (GPS), EDGE, GPRS, CDMA, WiMAX, LTE, EV-DO, or others. In some embodiments, a first communication chip 1712 may be dedicated to wireless communications, and a second communication chip 1712 may be dedicated to wired communications.

The computing device 1700 may include battery/power circuitry 1714. The battery/power circuitry 1714 may include one or more energy storage devices (e.g., batteries or capacitors) and/or circuitry for coupling components of the computing device 1700 to an energy source separate from the computing device 1700 (e.g., AC line power).

The computing device 1700 may include a display device 1706 (or corresponding interface circuitry, as discussed above). The display device 1706 may include any visual indicators, such as a heads-up display, a computer monitor, a projector, a touchscreen display, a liquid crystal display (LCD), a light-emitting diode display, or a flat panel display, for example.

The computing device 1700 may include an audio output device 1708 (or corresponding interface circuitry, as discussed above). The audio output device 1708 may include any device that generates an audible indicator, such as speakers, headsets, or earbuds, for example.

The computing device 1700 may include an audio input device 1718 (or corresponding interface circuitry, as discussed above). The audio input device 1718 may include any device that generates a signal representative of a sound, such as microphones, microphone arrays, or digital instruments (e.g., instruments having a musical instrument digital interface (MIDI) output).

The computing device 1700 may include a GPS device 1716 (or corresponding interface circuitry, as discussed above). The GPS device 1716 may be in communication with a satellite-based system and may receive a location of the computing device 1700, as known in the art.

The computing device 1700 may include another output device 1710 (or corresponding interface circuitry, as discussed above). Examples of the other output device 1710 may include an audio codec, a video codec, a printer, a wired or wireless transmitter for providing information to other devices, or an additional storage device.

The computing device 1700 may include another input device 1720 (or corresponding interface circuitry, as discussed above). Examples of the other input device 1720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1700 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1700 may be any other electronic device that processes data.

### Select Examples

The following paragraphs provide various examples of the embodiments disclosed herein.

Example 1 provides a method for performing a deep learning operation, including receiving a configuration parameter indicating a weight sparsity mode being selected between an activation sparsity mode and the weight sparsity mode; reading, from a memory, an activation tensor of the deep learning operation; reading, from the memory, a weight tensor and a weight sparsity tensor, in which the weight sparsity tensor indicates sparsity in another weight tensor, and the weight tensor is a subset of the another weight tensor; generating an enlarged activation tensor by adding one or more data elements into the activation tensor; selecting one or more activations from the enlarged activation tensor based on the weight sparsity tensor; and performing one or more multiply-accumulate operations on the one or more activations and the weight tensor.

Example 2 provides the method of example 1, further including reading an activation sparsity tensor from the memory, the activation sparsity tensor includes elements indicating sparsity in the enlarged activation tensor; and determining one or more positions of the one or more data elements in the enlarged activation tensor based on the activation sparsity tensor, in which the one or more data elements are added into the activation tensor based on the one or more positions.

Example 3 provides the method of example 1 or 2, further including storing the enlarged activation tensor in a first storage unit; storing the weight tensor in a second storage unit; transmitting the one or more activations from the first storage unit to one or more multiply-accumulate units; and transmitting the weight tensor from the second storage unit to the one or more multiply-accumulate units, in which the one or more multiply-accumulate operations are performed by the multiply-accumulate units.

Example 4 provides the method of any one of examples 1-3, further including determining, based on the configuration parameter, a sequence in which one or more outputs of the one or more multiply-accumulate operations are transmitted to the memory.

Example 5 provides the method of example 4, in which the one or more multiply-accumulate operations are performed by an array where a plurality of multiply-accumulate units is arranged in rows and columns, and determining the sequence includes performing, based on the value of the configuration parameter, a selection between a row index of a multiply-accumulate unit in the array and a column index of the multiply-accumulate unit in the array, and determining when an output of the multiply-accumulate unit is transmitted to the memory based on the selection.

Example 6 provides the method of any one of examples 1-5, in which: the one or more multiply-accumulate operations are performed by one or more multiply-accumulate units that are arranged in a column including a plurality of multiply-accumulate units, and the plurality of multiply-accumulate units performs multiply-accumulate operations based on the weight sparsity tensor.

Example 7 provides the method of any one of examples 1-6, in which: the one or more multiply-accumulate units are arranged in a column including a plurality of multiply-accumulate units, and the plurality of multiply-accumulate units performs multiply-accumulate operations based on the weight tensor.

Example 8 provides the method of any one of examples 1-7, in which: the value of the configuration parameter is determined based on a sparsity ratio of a filter of the deep learning operations, the sparsity ratio indicates a ration of a number of nonzero valued weights in the filter to a total number of weights in the filter, and values of the weights in the filter are determined by training a neural network including the deep learning operation.

Example 9 provides the method of any one of examples 1-8, in which: the deep learning operation is an operation in a neural network, and the value of the configuration parameter is determined by determining whether the deep learning operation is after an activation function in the neural network.

Example 10 provides the method of any one of examples 1-9, in which the deep learning operation is an operation in an execution process of a neural network, and the value of the configuration parameters is determined before the execution process starts.

Example 11 provides an apparatus for performing a deep learning operation, the apparatus including a memory configured to store an activation tensor, a weight tensor, an activation sparsity tensor, and a weight sparsity tensor of a deep learning operation, the activation sparsity tensor indicating sparsity in another activation tensor that includes the activation tensor, the weight sparsity tensor indicating sparsity in another weight tensor that includes the weight tensor; a load module configured to: receive a configuration parameter that indicates a selection between an activation sparsity mode and a weight sparsity mode, and generate either the another activation tensor based on the activation bitmap when the configuration parameter indicates a selection of the weight sparsity mode or the another weight tensor based on the weight bitmap when the configuration parameter indicates a selection of the activation sparsity mode; one or more sparse cells, a sparse cell including a sparsity module configured to select one or more data elements from the another activation tensor based on the weight sparsity tensor when the configuration parameter indicates a selection of the weight sparsity mode or select one or more data elements from the another weight tensor based on the activation sparsity tensor when the configuration parameter indicates a selection of the activation sparsity mode, and one or more multiply-accumulate units configured to perform one or more multiply-accumulate operations based on the one or more data elements.

Example 12 provides the apparatus of example 11, in which the sparse cell further includes a first storage unit configured to store the another activation tensor or the another weight tensor, a second storage unit configured to store the activation tensor or the weight tensor,

Example 13 provides the apparatus of example 12, in which: the sparse cell includes a plurality of multiply-accumulate units that includes the one or more multiply-accumulate units, the plurality of multiply-accumulate units is arranged in rows and columns, and the second storage unit is associated with a column of multiply-accumulate units in the sparse cell.

Example 14 provides the apparatus of example 12 or 13, in which the load module is further configured to: transfer the another activation tensor or the another weight tensor from the memory to the first storage unit; and transfer the activation tensor or the weight tensor from the memory to the second storage unit.

Example 15 provides the apparatus of example 14, in which: the sparse cell further includes a third storage unit, and the load module is further configured to transfer the activation sparsity tensor or the weight sparsity tensor to a third storage unit.

Example 16 provides the apparatus of example 15, in which: the sparse cell includes a plurality of multiply-accumulate units that includes the one or more multiply-accumulate units, the plurality of multiply-accumulate units is arranged in rows and columns, and the third storage unit is associated with a column of multiply-accumulate units in the sparse cell.

Example 17 provides the apparatus of any one of examples 11-16, further including a drain module configured to: receiving one or more outputs of the one or more multiply-accumulate units, determine, based on the configuration parameter, a sequence of the one or more outputs, and transmit the one or more outputs to the memory in the sequence.

Example 18 provides one or more non-transitory computer-readable media storing instructions executable to perform operations for performing a deep learning operation, the operations including receiving a configuration parameter indicating a weight sparsity mode being selected between an activation sparsity mode and the weight sparsity mode; reading, from a memory, an activation tensor of the deep learning operation; reading, from the memory, a weight tensor and a weight sparsity tensor, in which the weight sparsity tensor indicates sparsity in another weight tensor, and the weight tensor is a subset of the another weight tensor; generating an enlarged activation tensor by adding one or more data elements into the activation tensor; selecting one or more activations from the enlarged activation tensor based on the weight sparsity tensor; and performing one or more multiply-accumulate operations on the one or more activations and the weight tensor.

Example 19 provides the one or more non-transitory computer-readable media of example 18, in which the operations further include storing the enlarged activation tensor in a first storage unit; storing the weight tensor in a second storage unit; transmitting the one or more activations from the first storage unit to one or more multiply-accumulate units; and transmitting the weight tensor from the second storage unit to the one or more multiply-accumulate units, in which the one or more multiply-accumulate operations are performed by the multiply-accumulate units.

Example 20 provides the one or more non-transitory computer-readable media of example 18 or 19, in which the operations further include determining, based on the configuration parameter, a sequence in which one or more outputs of the one or more multiply-accumulate operations are transmitted to the memory.

### Additional Select Examples

The following paragraphs provide various examples of the embodiments disclosed herein.

Example 1 provides a method for performing a deep learning operation, including receiving a configuration parameter indicating an activation sparsity mode being selected between the activation sparsity mode and a weight sparsity mode; reading, from a memory, a weight tensor of the deep learning operation; reading, from the memory, an activation tensor and an activation sparsity tensor, in which the activation sparsity tensor indicates sparsity in another activation tensor, and the activation tensor is a subset of the another activation tensor; generating an enlarged weight tensor by adding one or more data elements into the weight tensor; selecting one or more weight s from the enlarged weight tensor based on the activation sparsity tensor; and performing one or more multiply-accumulate operations on the one or more weights and the activation tensor.

Example 2 provides the method of example 1, further including reading a weight sparsity tensor from the memory, the weight sparsity tensor includes elements indicating sparsity in the enlarged weight tensor; and determining one or more positions of the one or more data elements in the enlarged weight tensor based on the weight sparsity tensor, in which the one or more data elements are added into the weight tensor based on the one or more positions.

Example 3 provides the method of example 1 or 2, further including storing the enlarged weight tensor in a first storage unit; storing the activation tensor in a second storage unit; transmitting the one or more weight s from the first storage unit to one or more multiply-accumulate units; and transmitting the activation tensor from the second storage unit to the one or more multiply-accumulate units, in which the one or more multiply-accumulate operations are performed by the multiply-accumulate units.

Example 4 provides the method of any one of examples 1-3, further including determining, based on the configuration parameter, a sequence in which one or more outputs of the one or more multiply-accumulate operations are transmitted to the memory.

Example 5 provides the method of example 4, in which the one or more multiply-accumulate operations are performed by an array where a plurality of multiply-accumulate units is arranged in rows and columns, and determining the sequence includes performing, based on the value of the configuration parameter, a selection between a row index of a multiply-accumulate unit in the array and a column index of the multiply-accumulate unit in the array, and determining when an output of the multiply-accumulate unit is transmitted to the memory based on the selection.

Example 6 provides the method of any one of examples 1-5, in which: the one or more multiply-accumulate operations are performed by one or more multiply-accumulate units that are arranged in a column including a plurality of multiply-accumulate units, and the plurality of multiply-accumulate units performs multiply-accumulate operations based on the activation sparsity tensor.

Example 7 provides the method of any one of examples 1-6, in which: the one or more multiply-accumulate units are arranged in a column including a plurality of multiply-accumulate units, and the plurality of multiply-accumulate units performs multiply-accumulate operations based on the activation tensor.

Example 8 provides the method of any one of examples 1-7, in which: the value of the configuration parameter is determined based on a sparsity ratio of a filter of the deep learning operations, the sparsity ratio indicates a ration of a number of nonzero valued weights in the filter to a total number of weights in the filter, and values of the weights in the filter are determined by training a neural network including the deep learning operation.

Example 9 provides the method of any one of examples 1-8, in which: the deep learning operation is an operation in a neural network, and the value of the configuration parameter is determined by determining whether the deep learning operation is after an activation function in the neural network.

Example 10 provides the method of any one of examples 1-9, in which the deep learning operation is an operation in an execution process of a neural network, and the value of the configuration parameters is determined before the execution process starts.

1. A method for performing a deep learning operation, comprising:
receiving a configuration parameter indicating a weight sparsity mode being selected between an activation sparsity mode and the weight sparsity mode;
reading, from a memory, an activation tensor of the deep learning operation;
reading, from the memory, a weight tensor and a weight sparsity tensor, wherein the weight sparsity tensor indicates sparsity in another weight tensor, and the weight tensor is a subset of the another weight tensor;
generating an enlarged activation tensor by adding one or more data elements into the activation tensor;
selecting one or more activations from the enlarged activation tensor based on the weight sparsity tensor; and
performing one or more multiply-accumulate operations on the one or more activations and the weight tensor.

2. The method of claim 1, further comprising:
reading, from the memory, an activation sparsity tensor, wherein the activation sparsity tensor comprises elements indicating sparsity in the enlarged activation tensor; and
determining one or more positions of the one or more data elements in the enlarged activation tensor based on the activation sparsity tensor, wherein the one or more data elements are added into the activation tensor based on the one or more positions.

3. The method of claim 1, further comprising:
storing the enlarged activation tensor in a first storage unit;
storing the weight tensor in a second storage unit;
transmitting the one or more activations from the first storage unit to one or more multiply-accumulate units; and
transmitting the weight tensor from the second storage unit to the one or more multiply-accumulate units,
wherein the one or more multiply-accumulate operations are performed by the multiply-accumulate units.

4. The method of claim 1, further comprising:
determining, based on the configuration parameter, a sequence in which one or more outputs of the one or more multiply-accumulate operations are transmitted to the memory.

5. The method of claim 4, wherein the one or more multiply-accumulate operations are performed by an array where a plurality of multiply-accumulate units is arranged in rows and columns, and determining the sequence comprises:
performing, based on the value of the configuration parameter, a selection between a row index of a multiply-accumulate unit in the array and a column index of the multiply-accumulate unit in the array; and
determining when an output of the multiply-accumulate unit is transmitted to the memory based on the selection.

6. The method of claim 1, wherein:
the one or more multiply-accumulate operations are performed by one or more multiply-accumulate units that are arranged in a column comprising a plurality of multiply-accumulate units, and
the plurality of multiply-accumulate units performs multiply-accumulate operations based on the weight sparsity tensor.

7. The method of claim 1, wherein:
the one or more multiply-accumulate operations are performed by one or more multiply-accumulate units that are arranged in a column comprising one or more multiply-accumulate units, and
the plurality of multiply-accumulate units performs multiply-accumulate operations based on the weight tensor.

8. The method of claim 1, wherein:
the configuration parameter has a value that is determined based on a sparsity ratio of a filter of the deep learning operations,
the sparsity ratio indicates a ration of a number of nonzero valued weights in the filter to a total number of weights in the filter, and
values of the weights in the filter are determined by training a neural network including the deep learning operation.

9. The method of claim 8, further comprising:
determining the value of the configuration parameter based on whether the deep learning operation is after an activation function in a neural network.

10. The method of claim 1, wherein the deep learning operation is an operation in an execution process of a neural network, and the value of the configuration parameters is determined before the execution process starts.

11. An apparatus for performing a deep learning operation, the apparatus comprising:
a memory configured to store an activation tensor, a weight tensor, an activation sparsity tensor, and a weight sparsity tensor of a deep learning operation, the activation sparsity tensor indicating sparsity in another activation tensor that includes the activation tensor, the weight sparsity tensor indicating sparsity in another weight tensor that includes the weight tensor;
a load module configured to:
receive a configuration parameter that indicates a selection between an activation sparsity mode and a weight sparsity mode, and
generate either the another activation tensor based on the activation sparsity tensor when the configuration parameter indicates a selection of the weight sparsity mode or the another weight tensor based on the weight sparsity tensor when the configuration parameter indicates a selection of the activation sparsity mode; and
one or more sparse cells, a sparse cell comprising:
a sparsity module configured to select one or more data elements from the another activation tensor based on the weight sparsity tensor when the configuration parameter indicates a selection of the weight sparsity mode or select one or more data elements from the another weight tensor based on the activation sparsity tensor when the configuration parameter indicates a selection of the activation sparsity mode, and
one or more multiply-accumulate units configured to perform one or more multiply-accumulate operations based on the one or more data elements.

12. The apparatus of claim 11, wherein the sparse cell further comprises:
a first storage unit configured to store the another activation tensor or the another weight tensor,
a second storage unit configured to store the activation tensor or the weight tensor.

13. The apparatus of claim 12, wherein:
the sparse cell comprises a plurality of multiply-accumulate units that includes the one or more multiply-accumulate units,
the plurality of multiply-accumulate units is arranged in rows and columns, and
the second storage unit is associated with a column of multiply-accumulate units in the sparse cell.

14. The apparatus of claim 12, wherein the load module is further configured to:
transfer the another activation tensor or the another weight tensor from the memory to the first storage unit; and
transfer the activation tensor or the weight tensor from the memory to the second storage unit.

15. The apparatus of claim 14, wherein:
the sparse cell further comprises a third storage unit, and
the load module is further configured to transfer the activation sparsity tensor or the weight sparsity tensor to a third storage unit.

16. The apparatus of claim 15, wherein:
the sparse cell comprises a plurality of multiply-accumulate units that includes the one or more multiply-accumulate units,
the plurality of multiply-accumulate units is arranged in rows and columns, and
the third storage unit is associated with a column of multiply-accumulate units in the sparse cell.

17. The apparatus of claim 11, further comprising:
a drain module configured to:
receive one or more outputs of the one or more multiply-accumulate units,
determine, based on the configuration parameter, a sequence of the one or more outputs, and
transmit the one or more outputs to the memory in the sequence.

18. One or more non-transitory computer-readable media storing instructions executable to perform operations for performing a deep learning operation, the operations comprising:
receiving a configuration parameter indicating a weight sparsity mode being selected between an activation sparsity mode and the weight sparsity mode;
reading, from a memory, an activation tensor of the deep learning operation;
reading, from the memory, a weight tensor and a weight sparsity tensor, wherein the weight sparsity tensor indicates sparsity in another weight tensor, and the weight tensor is a subset of the another weight tensor;
generating an enlarged activation tensor by adding one or more data elements into the activation tensor;
selecting one or more activations from the enlarged activation tensor based on the weight sparsity tensor; and
performing one or more multiply-accumulate operations on the one or more activations and the weight tensor.

19. The one or more non-transitory computer-readable media of claim 18, wherein the operations further comprise:
storing the enlarged activation tensor in a first storage unit;
storing the weight tensor in a second storage unit;
transmitting the one or more activations from the first storage unit to one or more multiply-accumulate units; and
transmitting the weight tensor from the second storage unit to the one or more multiply-accumulate units,
wherein the one or more multiply-accumulate operations are performed by the multiply-accumulate units.

20. The one or more non-transitory computer-readable media of claim 18, wherein the operations further comprise:
determining, based on the configuration parameter, a sequence in which one or more outputs of the one or more multiply-accumulate operations are transmitted to the memory.
